(19) United States
(12) Patent Application Publication
(10) Pub. No.: US 2026/0368848 A1
(43) Pub. Date: Nov. 19, 2026

(54) VIDEO PROCESSING SYSTEM, VIDEO PROCESSING APPARATUS, AND VIDEO PROCESSING METHOD

(71) Applicant: NEC Corporation, Minato-ku, Tokyo (JP)

(72) Inventors: Hayato ITSUMI, Tokyo (JP); Koichi NIHEI, Tokyo (JP); Florian BEYE, Tokyo (JP); Katsuhiko TAKAHASHI, Tokyo (JP); Yasunori BABAZAKI, Tokyo (JP); Ryuhei ANDO, Tokyo (JP); Jun PIAO, Tokyo (JP)

(73) Assignee: NEC Corporation, Minato-ku, Tokyo (JP)

(21) Appl. No.: 19/103,302

(22) PCT Filed: Aug. 31, 2022
(86) PCT No.: PCT/JP2022/032764

§ 371 Date: Feb. 12, 2025

(51) Int. Cl. G06T 3/40; G06T 7/70

(52) U.S. Cl. CPC G06T 3/40; G06T 7/70

(57) ABSTRACT

A video processing system (10) includes: an object detection unit (11) that detects an object included in a video input to the video processing system (10) in a case where the video is input to the video processing system (10); an image quality control unit (12) that controls an image quality of a region including the object in the input video based on a detection result of the object detected by the object detection unit (11); and a transmission unit (13) that transmits the detection result of the object detected by the object detection unit (11) and the video in which the image quality is controlled by the image quality control unit (12).

### TECHNICAL FIELD

The present disclosure relates to a video processing system, a video processing apparatus, and a video processing method.

### BACKGROUND ART

technologies for detecting an object including a person and technologies for recognizing a state of an object including an action of a person have been developed based on an image and a video. Patent Literature 1 is known as a related technology. Patent Literature 1 describes a technology in which first object detection means and second object detection means detect an object by using videos with different resolutions and frame rates.

### CITATION LIST

### Patent Literature

Patent Literature 1: Japanese Unexamined Patent Application Publication No. 2012-212235

### SUMMARY OF INVENTION

### Technical Problem

In a related technology such as Patent Literature 1, an image in which an image quality such as a resolution is controlled is transmitted via a network, and an object is detected from the transmitted image. However, in the related technology, it is assumed that the image quality of the entire image is controlled, and thus, a case of controlling the image quality for each region of the image is not considered. For this reason, in the related technology, for example, in a case where the image quality is controlled for each region of the image according to a situation of the network, there is a possibility that object detection or recognition accuracy decreases.

In view of such a problem, an object of the present disclosure is to provide a video processing system, a video processing apparatus, and a video processing method capable of improving object detection or recognition accuracy.

### Solution to Problem

A video processing system according to the present disclosure includes: first object detection means for detecting an object included in an input video; image quality control means for controlling an image quality of a region including the object in the video based on a detection result of the object; and transmission means for transmitting the detection result of the object and the video in which the image quality is controlled.

A video processing apparatus according to the present disclosure includes: object detection means for detecting an object included in an input video; image quality control means for controlling an image quality of a region including the object in the video based on a detection result of the object; and transmission means for transmitting the detection result of the object and the video in which the image quality is controlled.

A video processing method according to the present disclosure includes: detecting an object included in an input video; controlling an image quality of a region including the object in the video based on a detection result of the object; and transmitting the detection result of the object and the video in which the image quality is controlled.

### Advantageous Effects of Invention

According to the present disclosure, it is possible to provide a video processing system, a video processing apparatus, and a video processing method capable of improving object detection or recognition accuracy.

### BRIEF DESCRIPTION OF DRAWINGS

FIG. 1 is a configuration diagram illustrating an outline of a video processing system according to an example embodiment.

FIG. 2 is a configuration diagram illustrating an outline of a video processing apparatus according to the example embodiment.

FIG. 3 is a flowchart illustrating an outline of a video processing method according to the example embodiment.

FIG. 4 is a diagram for describing the video processing method according to the example embodiment.

FIG. 5 is a configuration diagram illustrating a basic configuration of a remote monitoring system according to the example embodiment.

FIG. 6 is a configuration diagram illustrating a configuration example of a terminal according to a first example embodiment.

FIG. 7 is a configuration diagram illustrating a configuration example of a center server according to the first example embodiment.

FIG. 8 is a flowchart illustrating an operation example of the remote monitoring system according to the first example embodiment.

FIG. 9 is a diagram for describing video acquisition processing according to the first example embodiment.

FIG. 10 is a diagram for describing object detection processing according to the first example embodiment.

FIG. 11 is a diagram for describing image quality control processing according to the first example embodiment.

FIG. 12 is a diagram for describing object detection result extraction processing according to the first example embodiment.

FIG. 13 is a diagram for describing the object detection processing according to the first example embodiment.

FIG. 14 is a configuration diagram illustrating a configuration example of a terminal according to a second example embodiment.

FIG. 15 is a configuration diagram illustrating a configuration example of a center server according to the second example embodiment.

FIG. 16 is a configuration diagram illustrating a configuration example of a terminal according to a third example embodiment.

FIG. 17 is a configuration diagram illustrating a configuration example of a center server according to the third example embodiment.

FIG. 18 is a diagram illustrating an example of an object-work association table according to the third example embodiment.

FIG. 19 is a diagram for describing action recognition processing according to the third example embodiment.

FIG. 20 is a configuration diagram illustrating a configuration example of a terminal according to a fourth example embodiment.

FIG. 21 is a configuration diagram illustrating a configuration example of a center server according to the fourth example embodiment.

FIG. 22 is a diagram illustrating an example of a person-work association table according to the fourth example embodiment.

FIG. 23 is a diagram for describing action recognition processing according to the fourth example embodiment.

FIG. 24 is a configuration diagram illustrating a configuration example of a terminal according to a fifth example embodiment.

FIG. 25 is a diagram illustrating an example of a related object association table according to the fifth example embodiment.

FIG. 26 is a diagram illustrating another example of the related object association table according to the fifth example embodiment.

FIG. 27 is a configuration diagram illustrating a configuration example of a terminal according to a sixth example embodiment.

FIG. 28 is a diagram illustrating an example of a work-object association table according to the sixth example embodiment.

FIG. 29 is a diagram illustrating another example of the work-object association table according to the sixth example embodiment.

FIG. 30 is a configuration diagram illustrating an outline of hardware of a computer according to the example embodiment.

### EXAMPLE EMBODIMENT

Hereinafter, example embodiments will be described with reference to the drawings. In the drawings, the same elements are denoted by the same reference signs, and redundant description will be omitted as necessary.

### Outline of Example Embodiment

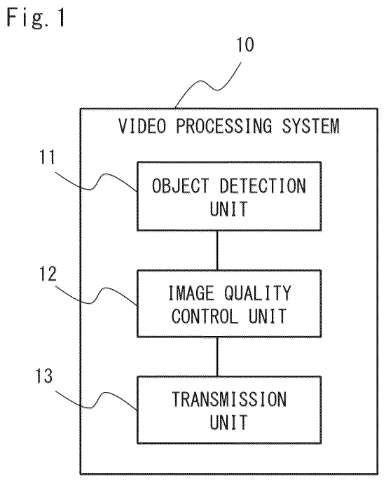

First, an outline of an example embodiment will be described. FIG. 1 illustrates a schematic configuration of a video processing system 10 according to the example embodiment. For example, the video processing system 10 is applicable to a remote monitoring system that transmits a video via a network and recognizes the transmitted video. Recognizing the video means performing recognition regarding a target included in the video. The recognition regarding the target included in the video is detection of an object included in the video or recognition of a state related to the object or the like, and includes, for example, recognition of the presence of an object including a person, recognition of a type and attribute of the object including the person, recognition of an action of the person, recognition of a state of the object, and the like. Transmitting the video is also referred to as distributing the video.

As illustrated in FIG. 1, the video processing system 10 includes an object detection unit 11, an image quality control unit 12, and a transmission unit 13. The object detection unit 11 detects an object included in an input video. Detecting the object includes specifying a type of the object included in the video and identifying the object. The specification of the type of the object means specification of the type of the object such as a person, a chair, or a compactor. The identification of the object indicates that the person is a specific person or that an individual work vehicle is uniquely distinguished. For example, the object detection unit 11 is a first object detection unit. For example, the object in the video includes a person who performs work, a work object used by the person for the work, and the like.

The image quality control unit 12 controls an image quality of a region including the object in the video based on a detection result of the object. For example, in a case where the object such as the person or the work object is detected from the video, the image quality control unit 12 may improve an image quality of a specific region selected from among regions of the objects to be higher than image qualities of other regions, or may lower the image quality of the specific region to be lower than the image qualities of other regions.

Improving the image quality of the specific region means making the image quality of the specific region higher than those of other regions, and is also expressed as sharpening an image. Lowering the image quality of the specific region means making the image quality of the specific region lower than those of other regions. The image quality of the specific region may be improved by lowering the image qualities of other regions to be lower than that of the specific region. The image quality of the specific region may be lowered by improving the image qualities of other regions to be higher than that of the specific region. For example, in a case of lowering the image quality of the specific region, a compression rate of the specific region may be increased, or a resolution may be decreased. In a case of improving the image quality of the specific region, the compression rate of the specific region may be lowered, or the resolution may be increased.

The transmission unit 13 transmits the detection result of the object and the video in which the image quality is controlled. For example, the transmission unit 13 transmits a detection result of an object included in a region where the image quality is lowered among the detected objects and the video in which the image quality is controlled via the network. The transmission unit 13 transmits, for example, the type and position information of the object as the detection result of the object. As the detection result of the object, a feature amount of a region including an object in the video, a positional relationship between a first object and a second object, person identification information or attribute identification information for uniquely identifying a person or an object or identifying an attribute of an object, or the like may be transmitted. The person identification information is identification information for identifying an individual specified by face authentication, and may be, for example, a name of each person or an identification number assigned to each person. The attribute identification information is identification information for identifying an affiliation of an object in the video, and for example, may be a job category of each person or a company to which each person belongs, may be an identification number assigned to each job category or company, a company or association that owns each object, or a company or association that has manufactured each object. The attribute identification information may be identified from, for example, a code indicating an attribute or a group attached to or displayed on an object such as a machine or clothes. The feature amount is an indicator or a numerical value representing a feature of an analysis target object such as an image. For example, uniquely identifying an object means identifying that the person is a specific person, and identifying an attribute of an object means identifying a job category of the person or a company to which the person belongs. The video processing system 10 may further include a second object detection unit that detects an object in the transmitted video by using the detection result of the object transmitted from transmission unit 13. The video processing system 10 may further include a state recognition unit that recognizes a state of the object in the transmitted video by using the detection result of the object transmitted from the transmission unit 13. The state of the object includes an action of a person and a state in which an object such as an autonomously moving heavy machine is moving. For example, the transmission unit 13 transmits, as the detection result of the object, information usable in object detection in the second object detection unit and state recognition in the state recognition unit.

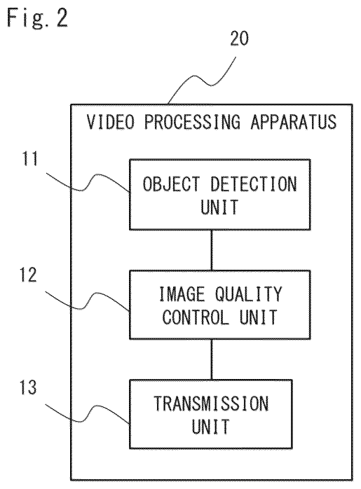

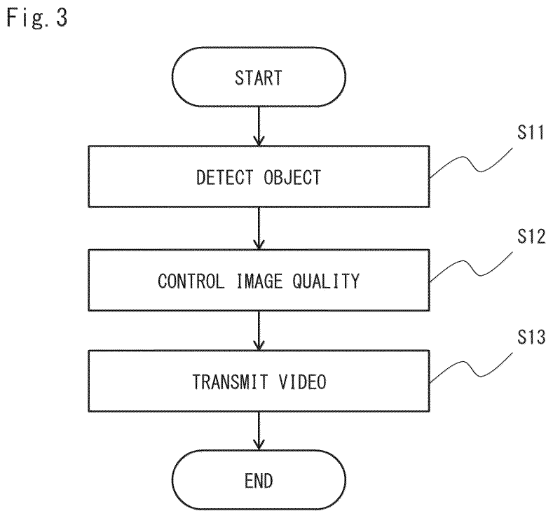

Note that the video processing system 10 may be configured by one apparatus or a plurality of apparatuses. FIG. 2 illustrates a configuration of a video processing apparatus 20 according to the example embodiment. As illustrated in FIG. 2, the video processing apparatus 20 may include the object detection unit 11, the image quality control unit 12, and the transmission unit 13 illustrated in FIG. 1. In addition, a part of or the entirety of the video processing system 10 may be disposed on an edge or a cloud. Disposing a part of or the entirety of the video processing system on the edge refers to, for example, disposing a part of or the entirety of the video processing system in an integrated system including the video processing system at a location away from a device that performs central processing of the integrated system. Furthermore, for example, in a system that monitors a video captured on a site via a network, the edge indicates the site or a location near the site. For example, a terminal of the edge may include the object detection unit 11, the image quality control unit 12, FIG. 3 illustrates a video processing method according to the example embodiment. For example, the video processing method according to the example embodiment is performed by the video processing system 10 or the video processing apparatus 20 of FIGS. 1 and 2. As illustrated in FIG. 3, first, the object detection unit 11 detects an object included in an input video (S11). Next, the image quality control unit 12 controls an image quality of a region including the object in the video based on the detection result of the object (S12). Next, the transmission unit 13 transmits the detection result of the object and the video in which the image quality is controlled (S13).

Here, an example in which a video is transmitted from the terminal of the edge to a server of the cloud via the network, and the server recognizes the video will be considered. The server of the cloud refers to a server disposed at a remote location and connected to an apparatus disposed at the edge via the network. In a case where transmitting the video via the network, it may be difficult to transmit a clear video depending on a situation of the network. For example, there is a case where an image quality of a video cut or the entire video is lowered due to a temporary deterioration in the situation of the network. In this case, entire video recognition accuracy decreases. In addition, an image quality of a predetermined region may be improved, or image qualities of other regions may be lowered depending on the situation of the network. Although recognition accuracy for a region where the image quality is improved, recognition accuracy for a region where the image quality is lowered decreases. Therefore, in the example embodiment, it is possible to improve the recognition accuracy in a case where it is difficult to transmit a video with a high image quality due to the situation of the network or the like.

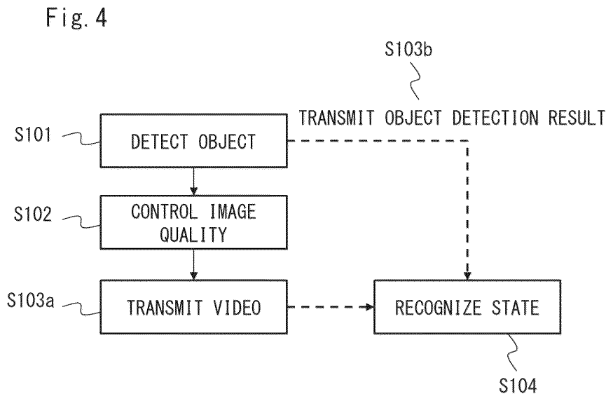

FIG. 4 illustrates an operation example in a case where a video is transmitted from the terminal to the server in the video processing method according to the example embodiment. For example, the video processing system that performs the video processing method of FIG. 4 may further include the state recognition unit in addition to the configuration of FIG. 1 in order to recognize a state of an object from the transmitted video. Not only the state recognition unit but also an object detection unit that detects an object from a video may be provided. For example, the terminal may include the object detection unit, the image quality control unit, and the transmission unit, and the server may include the state recognition unit.

As illustrated in FIG. 4, in the video processing method according to the example embodiment, the object detection unit detects an object from a camera video (S101), and the image quality control unit controls an image quality of the video based on the detection result of the object (S102). The image quality control unit improves an image quality of a selected region of the object based on the detection result of the object, and lowers image qualities of other regions.

Next, the transmission unit transmits the video in which the image quality is controlled (S103a), and transmits the detection result of the object (S103b). The transmission unit transmits a detection result of the object included in the region where the image quality is lowered among the detection results for the object.

Next, the state recognition unit recognizes a state of the object from the transmitted video by using the transmitted detection result of the object (S104). The state recognition unit recognizes the state of the object in the region where the image quality is lowered by using the detection result of the object transmitted from the terminal. The state recognition unit may narrow down candidates of the state recognition result based on the detection result of the object transmitted from the terminal. Not only the state recognition but also object detection from the transmitted video may be performed using the transmitted detection result of the object.

As described above, in the example embodiment, in a case where transmitting the video in which the image quality is controlled, the detection result of the object included in the video is transmitted. As a result, a video reception side video can analyze the video by using the detection result of the object, so that the recognition accuracy for the state of the object or the like can be improved. For example, in a system in which a video is transmitted from the terminal of the edge to the server of the cloud and the server recognizes an object or a state from the video, a video analysis result that assists recognition, that is, a detection result usable for recognition processing may be transmitted from the terminal to the server. As a result, the object detection result of the terminal and the object detection result of the server can be used as an ensemble, that is, both the detection results can be used to recognize an object and a state. Therefore, for example, in a case where the network has a low bandwidth or in a case where a bit rate is limited, the recognition accuracy can be improved.

### Basic Configuration of Remote Monitoring System

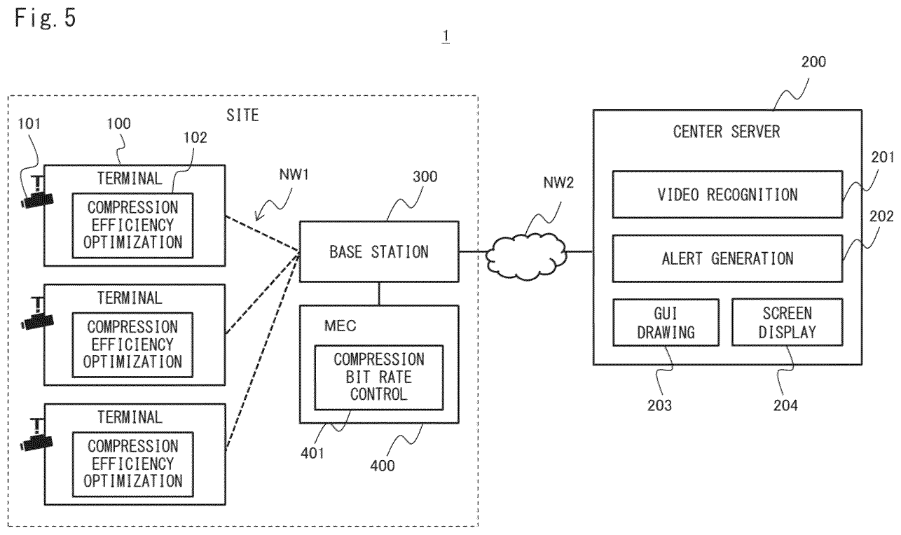

Next, the remote monitoring system that is an example of a system to which the example embodiment is applied will be described. FIG. 5 illustrates a basic configuration of a remote monitoring system 1. The remote monitoring system 1 is a system that monitors a captured area by a video captured by a camera. The present example embodiment will be described below as a system that remotely monitors work of a worker in a site. For example, the site may be an area where people and machines operate, such as a work site or a factory, for example, a construction site, a square where people gather, a station, or a school. In the present example embodiment, the work will be described below as construction work, civil engineering work, or the like, but the work is not limited thereto. Note that the video includes a plurality of time-series images (also referred to as frames), and thus the terms video and image can be used interchangeably. That is, the remote monitoring system can be said to be a video processing system that processes a video or an image processing system that processes an image.

As illustrated in FIG. 5, the remote monitoring system 1 includes a plurality of terminals 100, a center server 200, a base station 300, and a multi-access edge computing (MEC) 400. The terminal 100, the base station 300, and the MEC 400 are disposed on a site side, and the center server 200 is disposed on a center side. For example, the center server 200 is disposed in a data center or the like disposed at a position away from the site. The site side is also referred to as an edge side of the system, and the center side is also referred to as a cloud side.

The terminal 100 and the base station 300 are communicably connected by a network NW1. The network NW1 is, for example, a wireless network such as 4G, local 5G/5G, long term evolution (LTE), or wireless LAN. Note that the network NW1 is not limited to a wireless network, and may be a wired network.

The base station 300 and the center server 200 are communicably connected by a network NW2. The network NW2 includes, for example, a core network such as a 5th Generation Core network (5GC) or an Evolved Packet Core (EPC), the Internet, and the like. Note that the network NW2 is not limited to a wired network, and may be a wireless network. It can also be said that the terminal 100 and the center server 200 are communicably connected via the base station 300. The base station 300 and the MEC 400 are communicably connected by an arbitrary communication method, but the base station 300 and the MEC 400 may be one apparatus.

The terminal 100 is a terminal apparatus connected to the network NW1, and is also a video transmission apparatus that transmits a video of the site. The terminal 100 acquires a video captured by a camera 101 installed at the site, and transmits the acquired video to the center server 200 via the base station 300. Note that the camera 101 may be disposed outside the terminal 100 or inside the terminal 100.

The terminal 100 compresses the video of the camera 101 to a predetermined bit rate, and transmits the compressed video. The terminal 100 has a compression efficiency optimization function 102 for optimizing compression efficiency. The compression efficiency optimization function 102 performs region of interest (ROI) control for controlling an image quality of an ROI in the video. The ROI is a predetermined region in the video. The ROI may be a region including a recognition target of the center server 200, or may be a region to be gazed by a user. The compression efficiency optimization function 102 reduces the bit rate by lowering an image quality of a region around the ROI including a person or an object while maintaining the image quality of the ROI. Furthermore, the terminal 100 may include the object detection unit that detects an object from the acquired video. The compression efficiency optimization function 102 may include the image quality control unit that controls an image quality of a region including an object in the video based on the detection result of the object. The terminal 100 may include the transmission unit that transmits the detection result of the object and the video in which the image quality is controlled.

The base station 300 is a base station apparatus of the network NW1, and is also a relay apparatus that relays communication between the terminal 100 and the center server 200. For example, the base station 300 is a local 5G base station, a 5G next generation node B (gNB), an LTE evolved node B (eNB), an access point of a wireless LAN, or the like, and may be another relay apparatus.

The multi-access edge computing (MEC) 400 is an edge processing apparatus disposed on the edge side of the system. The MEC 400 is an edge server that controls the terminal 100, and has a compression bit rate control function 401 for controlling the bit rate of the terminal. The compression bit rate control function 401 controls the bit rate of the terminal 100 by adaptive video distribution control or quality of experience (QoE) control. The adaptive video distribution control controls a bit rate or the like of a video to be distributed according to the situation of the network. For example, the compression bit rate control function 401 assigns the bit rate to the video distributed by the camera 101 of each terminal 100 such that recognition accuracy of the center server 200 is improved according to a communication environment of the networks NW1 and NW2. Furthermore, the communication environment of the networks NW1 and NW2 may be predicted, and the bit rate may be assigned according to the prediction result. The compression bit rate control function 401 may predict the recognition accuracy obtained in a case where the distributed video is input into a recognition model by reducing the bit rate of the video. Note that the control is not limited to the control of the bit rate, and a frame rate of the distributed video may be controlled according to the situation of the network.

The center server 200 is a server installed on the center side of the system. The center server 200 may be one or a plurality of physical servers, a cloud server constructed on the cloud, or other virtualization servers. The center server 200 is a monitoring apparatus that monitors work in a site by analyzing and recognizing a camera video of the site. The center server 200 is also a video reception apparatus that receives a video transmitted from the terminal 100.

The center server 200 has a video recognition function 201, an alert generation function 202, a graphical user interface (GUI) drawing function 203, and a screen display function 204. The video recognition function 201 inputs a video transmitted from the terminal 100 to a video recognition artificial intelligence (AI) engine, thereby recognizing work performed by a worker, that is, a type of an action of a person. Further, the video recognition function 201 may recognize the action based on the object detection result received from the terminal 100 and the video. The object detection unit may be provided on a center server 200 side, and the action of the person may be recognized based on the object detection result of the center server 200. Note that the video recognition function 201 may recognize not only the action of the person but also a state of an object.

The alert generation function 202 generates an alert according to recognized work. The GUI drawing function 203 displays a graphical user interface (GUI) on a screen of a display apparatus. The screen display function 204 displays a video, a recognition result, an alert, and the like of the terminal 100 on the GUI. Note that any of the functions may be omitted or any of the functions may be included as necessary. For example, the center server 200 does not have to include the alert generation function 202, the GUI drawing function 203, and the screen display function 204.

### First Example Embodiment

Next, a first example embodiment will be described. In the present example embodiment, an example of transmitting a detection result of an object of an image quality lowering region together with a distributed video will be described. The image quality lowering region is a region in which an image quality is controlled to be lower than those of other regions.

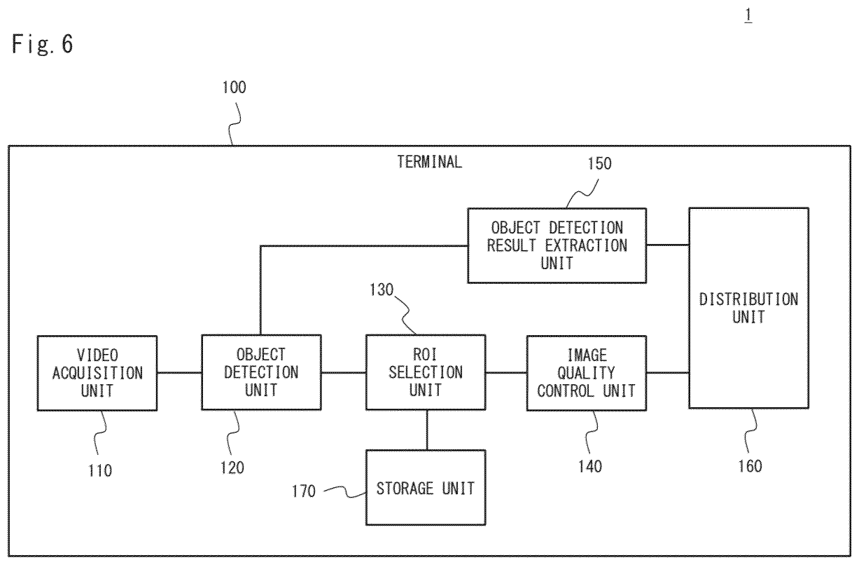

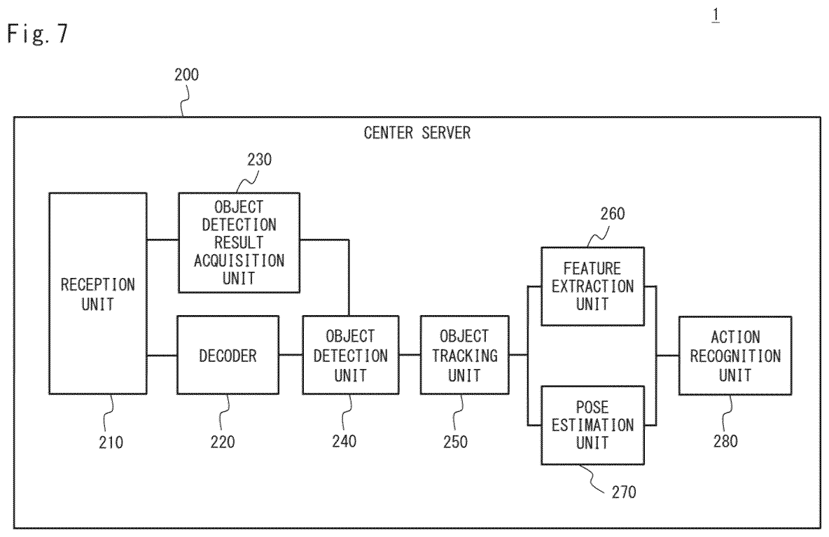

First, a configuration of the remote monitoring system according to the present example embodiment will be described. A basic configuration of the remote monitoring system 1 according to the present example embodiment is as illustrated in FIG. 5. Here, a configuration example of the terminal 100 and the center server 200 will be described. FIG. 6 illustrates a configuration example of the terminal 100 according to the present example embodiment, and FIG. 7 illustrates a configuration example of the center server 200 according to the present example embodiment.

Note that the configuration of each apparatus is an example, and another configuration may be used as long as an operation according to the present example embodiment described below can be performed. For example, some functions of the terminal 100 may be disposed in the center server 200 or another apparatus, or some functions of the center server 200 may be disposed in the terminal 100 or another apparatus. In addition, the functions of the MEC 400 having the compression bit rate control function may be disposed in the center server 200, the terminal 100, or the like.

As illustrated in FIG. 6, the terminal 100 includes a video acquisition unit 110, an object detection unit 120, an ROI selection unit 130, an image quality control unit 140, an object detection result extraction unit 150, a distribution unit 160, and a storage unit 170.

The video acquisition unit 110 acquires a video captured by the camera 101. The video captured by the camera is hereinafter also referred to as an input video. For example, the input video includes a person who is a worker who performs work in a site, a work object used by the person, and the like. The video acquisition unit 110 is also an image acquisition unit that acquires a plurality of time-series images, that is, frames.

The object detection unit 120 detects an object in the acquired input video. Detecting the object may include recognizing a type of the object and recognizing the object. The object detection unit 120 detects the object in each frame included in the input video and recognizes the type of the detected object. An object type is also referred to as an object label or an object class. The object detection unit 120 extracts a rectangular region including the object from each frame included in the input video, and recognizes the object type of the object in the extracted rectangular region. The rectangular region is a bounding box or an object region. Note that the object region including the object is not limited to the rectangular region, and may be a region having a circular or amorphous silhouette, or the like. The object detection unit 120 calculates a feature amount of the rectangular region including the object, and recognizes the object based on the calculated feature amount. For example, the object detection unit 120 recognizes the object in the frame by an object recognition engine using machine learning such as deep learning. The object recognition can be performed by machine learning of a feature of a region including the object and the type of the object. The detection result of the object includes the object type, position information of the rectangular region including the object, a score of the object type, and the like. The position information of the object is, for example, coordinates of each vertex of the rectangular region, and may be a position of the center of the rectangular region or a position of an arbitrary point of the object. The score of the object type is certainty of the detected object type, that is, reliability or a certainty level. Note that the recognition of the object may include, for example, recognition of the presence of the object, recognition of the type or attribute of the object, recognition of the state of the object, and the like.

The ROI selection unit 130 selects an ROI, that is, a gaze region in the acquired input video based on the detection result of the object detected in the input video. The ROI selection unit 130 determines the ROI based on the position information of the object having a predetermined object type among the detected objects detected in the input video. For example, a region of the object having the predetermined object type stored in the storage unit 170 may be selected as the ROI. In addition, a region of the object whose score of the object type included in the object detection result is higher than a predetermined value or regions of a predetermined number of objects with the highest scores of the object type may be selected as the ROI. Note that a region of the object whose score of the object type is lower than the predetermined value may be selected as the ROI.

The image quality control unit 140 controls an image quality of the input video based on the selected ROI. The image quality control unit 140 controls the image quality of the input video by setting the ROI as a sharpening region and setting a region other than the ROI as a non-sharpening region. The sharpening region is a region where the image quality is improved, and the non-sharpening region is a region where the image quality is lowered. The image quality control unit 140 is an encoder that encodes the input video by a predetermined encoding method. The image quality control unit 140 performs encoding by a video encoding method such as H.264 or H.265, for example. The image quality control unit 140 compresses each of an image quality improvement region and the image quality lowering region at a predetermined compression rate, that is, at a bit rate, thereby performing encoding such that the image quality of each region has a predetermined quality. That is, by changing the compression rates of the image quality improvement region and the image quality lowering region, the image quality of the image quality improvement region is improved to be higher than that of the image quality lowering region, and the image quality of the image quality lowering region is lowered to be lower than the image quality improvement region. For example, it is possible to lower the image quality by smoothing changes in pixel values between adjacent pixels.

The image quality control unit 140 may encode the input video at a bit rate assigned from the compression bit rate control function 401 of the MEC 400. The image qualities of the image quality improvement region and the image quality lowering region may be controlled within a range of the assigned bit rate. In addition, the image quality control unit 140 may determine the bit rate based on a communication quality between the terminal 100 and the center server 200. The image qualities of the image quality improvement region and the image quality lowering region may be controlled within a range of the bit rate based on the communication quality. The communication quality is, for example, a communication speed, and may be another indicator such as a transmission delay or an error rate. The terminal 100 may include a communication quality measurement unit that measures the communication quality. For example, the communication quality measurement unit determines the bit rate of the video to be transmitted from the terminal 100 to the center server 200 according to the communication speed. The communication speed may be measured based on a data amount received by the base station 300 or the center server 200, and the communication quality measurement unit may acquire the measured communication speed from the base station 300 or the center server 200. In addition, the communication quality measurement unit may estimate the communication speed based on a data amount per unit time transmitted from the distribution unit 160.

The object detection result extraction unit 150 extracts the object detection result to be transmitted to the center server 200 from among the object detection results. The object detection result extraction unit 150 extracts the object detection result of the image quality lowering region that is not selected as the ROI from among the object detection results of a plurality of objects detected by the object detection unit 120. The object detection result extraction unit 150 transmits the extracted object detection result to the center server 200 via the distribution unit 160. The object detection result to be transmitted is information usable for object detection in the center server 200. For example, the object type and the position information of the rectangular region including the object are transmitted as the object detection result. In addition, the score of the object type or the feature amount of the region including the object may be transmitted as the object detection result.

The distribution unit 160 distributes the video in which the image quality is controlled by the image quality control unit 140, that is, encoded data, to the center server 200 via the network. Further, the distribution unit 160 transmits the object detection result of the image quality lowering region extracted by the object detection result extraction unit 150 to the center server 200 via the network. The distribution unit 160 may include the object detection result in a packet of the encoded data to collectively transmit the encoded data and the object detection result. The encoded data and the object detection result may be transmitted at different timings or through different communication paths. In this case, the encoded data and the object detection result may include a time For example, the distribution unit 160 transmits the encoded data and the object detection result to the center server 200 via the base station 300. The distribution unit 160 is a communication interface capable of communicating with the base station 300, and is, for example, a wireless interface such as 4G, local 5G/5G, LTE, or a wireless LAN, but may be a wireless or wired interface of any other communication scheme. The distribution unit 160 may include a first transmission unit that transmits the encoded data and a second transmission unit that transmits the object detection result. The first transmission unit and the second transmission unit may be communication units of the same communication scheme, or may be communication units of different communication schemes.

The storage unit 170 stores data necessary for processing in the terminal 100. For example, the storage unit 170 stores a predetermined object type for selecting the ROI.

As illustrated in FIG. 7, the center server 200 includes a reception unit 210, a decoder 220, an object detection result acquisition unit 230, an object detection unit 240, an object tracking unit 250, a feature extraction unit 260, a pose estimation unit 270, and an action recognition unit 280.

The reception unit 210 receives the video after the image quality control transmitted from the terminal 100, that is, the encoded data, via the network. Furthermore, the reception unit 210 receives the object detection result of the image quality lowering region in which the image quality is lowered by the terminal 100 via the network. For example, the reception unit 210 receives the packet including the encoded data and the object detection result. Further, the encoded data and the object detection result may be received at different timings or through different communication paths. In a case where the time stamp is attached to the encoded data and the object detection result, the object detection result corresponding to the encoded data is specified by the time stamp.

For example, the reception unit 210 receives the encoded data and the object detection result distributed by the terminal 100 via the base station 300. The reception unit 210 is a communication interface capable of communicating with the Internet or a core network, and is, for example, a wired interface for IP communication, and may be a wired or wireless interface of any other communication scheme. The reception unit 210 may include a first reception unit that receives the encoded data and a second reception unit that receives the object detection result. The first reception unit and the second reception unit may be communication units of the same communication scheme, or may be communication units of different communication schemes. The object detection result acquisition unit 230 acquires the object detection result of the image quality lowering region received by the reception unit 210 from the terminal 100. Note that the object detection result acquisition unit 230 may be integrated with the reception unit 210.

The decoder 220 decodes the encoded data received from the terminal 100. The decoder 220 is a decoding unit that decodes the encoded data. The decoder 220 is also a restoration unit that restores the encoded data, that is, compressed data, by a predetermined encoding method. The decoder 220 supports an encoding method of the terminal 100, and performs decoding by a moving image encoding method such as H.264 or H.265. The decoder 220 decodes the video according to the compression rate or the bit rate of each region, and generates a decoded video. The decoded video is hereinafter also referred to as a reception video.

The object detection unit 240 detects the object in the reception video received from the terminal 100. For example, similarly to the object detection unit 120 of the terminal 100, the object detection unit 240 recognizes the object by an object recognition engine using machine learning. Note that the object recognition engine of the object detection unit 240 may be an object recognition engine that performs learning different from that of the object recognition engine provided in the object detection unit 120. The object detection unit 240 extracts the rectangular region including the object from each image of the reception video, and recognizes the object type of the object in the extracted rectangular region. The detection result of the object includes the object type, position information of the rectangular region including the object, the score of the object type, and the like.

Further, the object detection unit 240 detects the object of the image quality lowering region in the reception video by using the object detection result acquired from the terminal 100. That is, the object detection unit 240 detects the object of the image quality improvement region by using the object recognition engine, and detects the object in the image quality lowering region based on the object detection result acquired from the terminal 100. The object detection unit 240 outputs the object detection result including the object detection result of the image quality improvement region detected by using the object recognition engine and the object detection result of the image quality lowering region detected based on the object detection result acquired from the terminal 100. The object detection unit 240 may analyze the reception video based on the object detection result acquired from the terminal 100 to generate the object detection result of the image quality lowering region, or may output the object detection result acquired from the terminal 100 as the object detection result of the image quality lowering region. For example, the object may be detected using the object detection result acquired from the terminal 100 in a region where the object cannot be detected or a region where the score of the object type is lower than the predetermined value.

The object tracking unit 250 tracks the detected object in the reception video. The object tracking unit 250 associates the objects of the respective images included in the reception video based on the detection result of the object. For example, by assigning a tracking ID to the detected object, each object can be identified and tracked. For example, the object is tracked by associating the objects between the images based on a distance or overlap between the rectangular region of the object detected in the previous image and the rectangular region of the object detected in the next image.

The feature extraction unit 260 extracts the feature amount of the region including the object for each object tracked by the object tracking unit 250. The feature extraction unit 260 extracts the feature amount used by the action recognition unit 280 to recognize the action of the object. The feature amount of a two-dimensional space of the image or the feature amount of a time space in a time direction may be extracted. For example, the feature extraction unit 260 extracts the feature amount of the region including the object by a feature extraction engine using machine learning such as deep learning. The feature extraction engine may be a convolutional neural network (CNN), a recurrent neural network (RNN), or another neural network.

The pose estimation unit 270 estimates a pose of the object for each object tracked by the object tracking unit 250. The pose estimation unit 270 may estimate, as the pose of the object, a skeleton of a person who is the detected object, or may estimate, for example, an orientation of the object such as an orientation of a forklift or a heavy machine. For example, the pose estimation unit 270 estimates the pose of the object in the image by a skeleton estimation engine or a pose estimation engine using machine learning such as deep learning.

The action recognition unit 280 recognizes the action of the object based on the feature extraction result and the pose estimation result. The action recognition unit 280 recognizes the action of the object based on the extracted feature amount of the region including the object and the estimated pose of the object. For example, work performed by a person using the object, an unsafe action in which the person is in a dangerous state, and the like are recognized. Note that not only the action recognition but also the state of the object or the like may be recognized. The action recognition unit 280 recognizes a type of the action of the object for each object. An action type is also referred to as an action label or an action class. For example, the action recognition unit 280 recognizes the action of the object by an action recognition engine using machine learning such as deep learning. It is possible to recognize an action of a person in a video by performing machine learning of the feature and the action type of the video of the person performing work. The action recognition engine may be a CNN or an RNN, or may be another neural network. A recognition result of the action includes the action type, a score of the action type, and the like. The score of the action type is certainty of the recognized action type, that is, reliability or a certainty level.

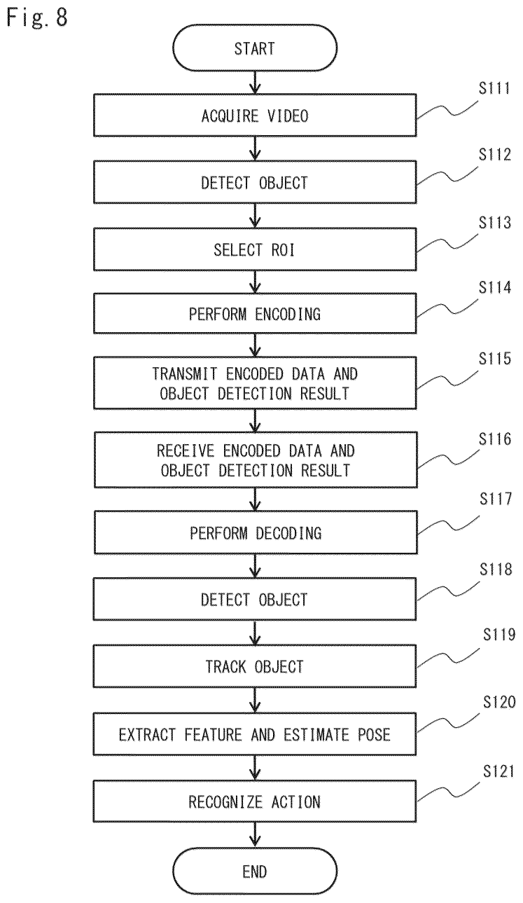

Next, an operation of the remote monitoring system according to the present example embodiment will be described. FIG. 8 illustrates an operation example of the remote monitoring system 1 according to the present example embodiment. For example, it is described that the terminal 100 executes S111 to S115 and the center server 200 executes S116 to S121, but the present example embodiment is not limited thereto, and any apparatus may execute each processing.

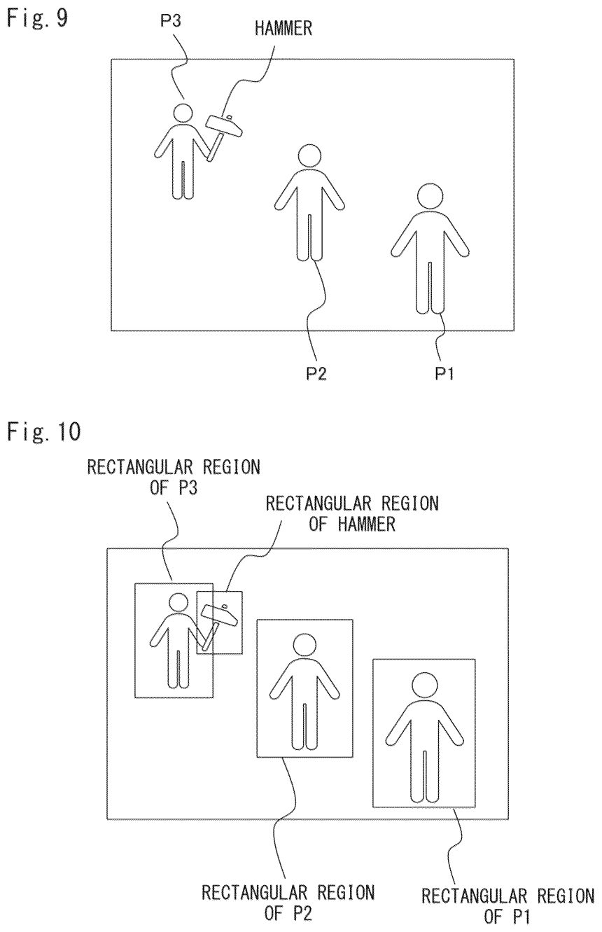

As illustrated in FIG. 8, the terminal 100 acquires a video from the camera 101 (S111). The camera 101 generates the video obtained by capturing the site, and the video acquisition unit 110 acquires the video, that is, the input video output from the camera 101. For example, as illustrated in FIG. 9, an image of the input video includes three persons P1 to P3 who perform work in a site. For example, the person P3 performs work with a hammer.

Subsequently, the terminal 100 detects an object based on the acquired input video (S112). The object detection unit 120 recognizes an object type of the object in a frame included in the input video using the object recognition engine. The object detection unit 120 outputs the object type, position information of a rectangular region of the object, a score of the object type, and the like as the object detection result for each detected object. For example, in a case where object detection is performed from the image of FIG. 9, the persons P1 to P3 and the hammer are detected, and rectangular regions of the persons P1 to P3 and a rectangular region of the hammer are detected as illustrated in FIG. 10.

Subsequently, the terminal 100 selects the ROI based on the object detection result (S113). The ROI selection unit 130 may extract an object included in a predetermined object type stored in the storage unit 170 from among the detected objects and select a region of the extracted object as the ROI. In addition, the ROI selection unit 130 may select a region of the object whose score of the object type is higher than the predetermined value as the ROI. In addition, a region of the object whose score of the object type is lower than the predetermined value may be selected as the ROI. For example, in the example of FIG. 10, in a case where scores of the person P1 and the person P2 are higher than the predetermined value and scores of the person P3 and the hammer are lower than the predetermined value, the rectangular regions of the person P1 and the person P2 are selected as the ROIs, and the rectangular regions of the person P3 and the hammer are not selected as the ROIs. In a case where the scores of the person P1 and the person P2 are higher than the predetermined value and the scores of the person P3 and the hammer are lower than the predetermined value, the person P3 and the hammer may be selected as the ROIs.

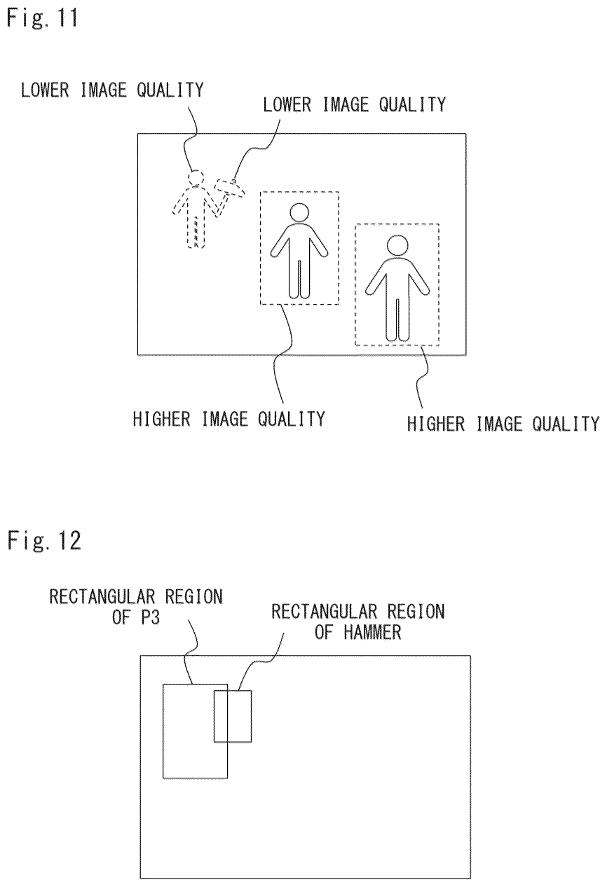

Subsequently, the terminal 100 encodes the input video based on the selected ROI (S114). The image quality control unit 140 encodes the input video by a predetermined video encoding method. For example, the image quality control unit 140 may encode the input video at a bit rate assigned from the compression bit rate control function 401 of the MEC 400, or may encode the input video at a bit rate corresponding to the communication quality between the terminal 100 and the center server 200. The image quality control unit 140 encodes the input video such that the ROI has a higher image quality than other regions in a range of the assigned bit rate or the bit rate corresponding to the communication quality. For example, by making the compression rate of the ROI lower than the compression rates of other regions, the image quality of the ROI is improved, and the image qualities of other regions are lowered. In the example of FIG. 10, in a case where the rectangular regions of the person P3 and the person P2 are selected as the ROIs, the image qualities of the rectangular regions of the person P1 and the person P2 are improved, and the image qualities of other regions including the person P3 and the hammer are lowered as illustrated in FIG. 11.

Subsequently, the terminal 100 transmits the encoded data and the object detection result to the center server 200 (S115). The object detection result extraction unit 150 extracts an object detection result of a region that is not selected as the ROI, that is, the image quality lowering region, from among the object detection results. In the example of FIG. 11, since the person P3 and the hammer correspond to the image quality lowering regions, the object detection results of the person P3 and the hammer are extracted from among the object detection results as illustrated in FIG. 12. For example, as the object detection result, the object type, the position information of the rectangular region including the object, the score of the object type, and the like are output to the distribution unit 160. The distribution unit 160 transmits the encoded data obtained by encoding the input video and the extracted object detection result of the image quality lowering region to the base station 300. The base station 300 transfers the received encoded data and object detection result to the center server 200 via the core network or the Internet.

Subsequently, the center server 200 receives the encoded data and the object detection result (S116). The reception unit 210 receives the encoded data and the object detection result transferred from the base station 300 from the core network or the Internet. The object detection result acquisition unit 230 acquires the received object detection result of the image quality lowering region.

Subsequently, the center server 200 decodes the received encoded data (S117). The decoder 220 decodes the encoded data according to the compression rate or the bit rate of each region, and generates the decoded video, that is, the reception video.

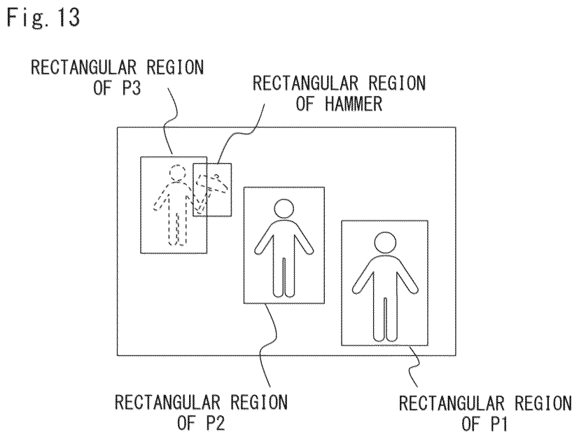

Subsequently, the center server 200 detects the object in the reception video based on the reception video and the object detection result (S118). The object detection unit 240 detects the object of the image quality improvement region of the reception video by using the object recognition engine, and detects the object of the image quality lowering region of the reception video by using the object detection result acquired by the object detection result acquisition unit 230. For example, the object detection unit 240 collectively outputs the object detection result detected by the object recognition engine and the object detection result acquired by the object detection result acquisition unit 230 as one object detection result. That is, the object detection unit 240 outputs, as the object detection result, the object type, the position information of the rectangular region of the object, the score of the object type, and the like of the object detected in the image quality improvement region, and the acquired object type, the position information of the rectangular region of the object, the score of the object type, and the like of the object of the image quality lowering region. Note that the object detection unit 240 may detect the object of the image quality lowering region. In this case, the object detection result acquired by the object detection result acquisition unit 230 may be compared with the score of the object type detected by the object detection unit 240, and the object detection result with a higher score may be output. For example, in a case where the video in which the image quality is controlled as illustrated in FIG. 11 and the object detection result as illustrated in FIG. 12 are received, the rectangular regions of the persons P1 and P2 detected by the object recognition engine and the rectangular regions of the person P3 and the hammer included in the received object detection result are output as the object detection result as illustrated in FIG. 13.

Subsequently, the center server 200 tracks the detected object in the reception video (S119). The object tracking unit 250 tracks the object in the reception video based on the object detection result of the reception video including the object detection results of the image quality improvement region and the image quality lowering region. The object tracking unit 250 assigns the tracking ID to each detected object, and tracks the object identified by the tracking ID in each image.

Subsequently, the center server 200 extracts the feature amount of the region including the object for each tracked object, and estimates the pose of the object (S120). The feature extraction unit 260 extracts the feature amount of the region including the object tracked in the image quality improvement region and the image quality lowering region by using the feature extraction engine. The pose estimation unit 270 estimates the pose of the object tracked in the image quality improvement region and the image quality lowering region by using the pose estimation engine.

Subsequently, the center server 200 recognizes the action of the object based on the feature extraction result and the pose estimation result (S121). The action recognition unit 280 recognizes the action of the object in the reception video based on the feature amount of the object extracted in the image quality improvement region and the image quality lowering region and the pose of the object estimated in the image quality improvement region and the image quality lowering region by using the action recognition engine. The action recognition unit 280 outputs the type of the recognized action of the object and the score of the action type. For example, the persons P1 to P3 and the hammer are tracked based on the object detection results in FIG. 13, and the actions of the persons Pl and P2 in the image quality improvement region and the action of the person P3 in the image quality lowering region are recognized based on the feature amounts and poses of the persons P1 to P3 and the hammer.

As described above, in the present example embodiment, the object detection result of the region where the image quality is lowered is transmitted from the terminal to the center server. That is, the terminal transmits, to the center server, the object detection result of the region where the image quality is lowered based on the ROI, and the center server detects the object in the image quality lowering region by using the received object detection result. If the image quality of the video is lowered, the object detection accuracy is lowered, and there is a possibility that the object cannot be correctly detected. Therefore, the object detection accuracy can be improved by performing object detection in the center server using the object detection result of the image quality lowering region detected by the terminal as in the present example embodiment. In addition, since the object detection accuracy can be improved, accuracy in object action recognition using the object detection result can be improved.

### Second Example Embodiment

Next, a second example embodiment will be described. In the present example embodiment, an example of transmitting a feature amount of an image in an image quality lowering region together with a distributed video will be described.

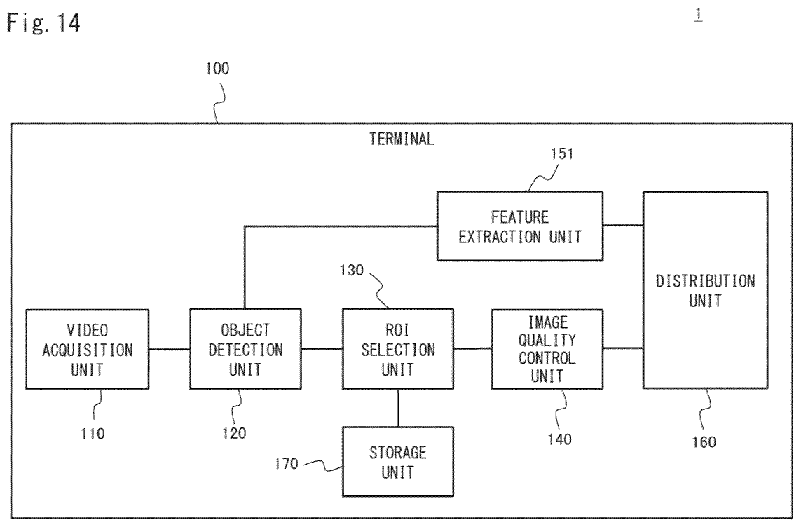

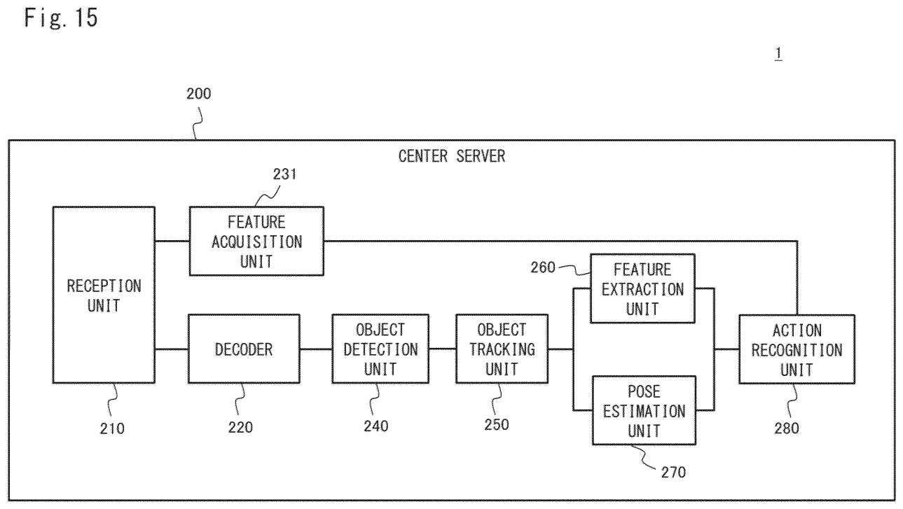

FIG. 14 illustrates a configuration example of a terminal 100 according to the present example embodiment, and FIG. 15 illustrates a configuration example of a center server 200 according to the present example embodiment. Here, a configuration different from that of the first example embodiment will be mainly described.

As illustrated in FIG. 14, in the present example embodiment, the terminal 100 includes a feature extraction unit 151 instead of the object detection result extraction unit 150 of the first example embodiment. Other configurations are similar to those in the first example embodiment. Note that the feature extraction unit 151 may be further included in addition to the configuration of the first example embodiment.

The feature extraction unit 151 extracts a feature amount of a region including a detected object. The feature extraction unit 151 extracts the feature amount of the region including the object of the image quality lowering region that is not selected as an ROI from among the objects detected by an object detection unit 120. The feature extraction unit 151 transmits the extracted feature amount of the region including the object to the center server 200 via a distribution unit 160. The transmitted feature amount of the region including the object is a feature amount usable for action recognition in the center server 200. The feature extraction unit 151 extracts the feature amount used by an action recognition unit 280 to recognize an action of the object, similarly to a feature extraction unit 260 of the center server 200. For example, the feature amount of a two-dimensional space of an image or the feature amount of a time space in a time direction may be extracted. For example, similarly to the feature extraction unit 260, the feature extraction unit 151 extracts the feature amount of the region including the object by a feature extraction engine using machine learning such as deep learning. The feature extraction engine may be a CNN or an RNN, or may be another neural network.

The distribution unit 160 transmits encoded data encoded by an image quality control unit 140 and the feature amount of the region including the object of the image quality lowering region extracted by the feature extraction unit 151 to the center server 200. Note that the description of units that operate as in FIG. 6 in the first example embodiment is omitted.

As illustrated in FIG. 15, in the present example embodiment, the center server 200 includes a feature acquisition unit 231 instead of the object detection result acquisition unit 230 of the first example embodiment. Other configurations are similar to those in the first example embodiment. Note that the feature acquisition unit 231 may be further included in addition to the configuration of the first example embodiment.

A reception unit 210 receives the encoded data transmitted from the terminal 100 and the feature amount of the region including the object of the image quality lowering region, and the feature acquisition unit 231 acquires the received feature amount of the region including the object of the image quality lowering region. Note that the feature acquisition unit 231 may be integrated with the reception unit 210.

The action recognition unit 280 recognizes the action of the object based on the feature amount of the region including the object extracted by the feature extraction unit 260 and the feature amount of the region including the object acquired from the terminal 100, and a pose of the object estimated by a pose estimation unit 270. The action recognition unit 280 recognizes the action of the object of an image quality improvement region based on the feature amount of the region including the object extracted by the feature extraction unit 260 and the pose of the object estimated by the pose estimation unit 270, and recognizes the action of the object of the image quality lowering region based on the feature amount of the region including the object acquired from the terminal 100 and the pose of the object estimated by the pose estimation unit 270. Note that the feature extraction unit 260 may extract the feature amount from the image quality lowering region. In this case, the action recognition unit 280 may perform action recognition without performing division into the image quality lowering region and the image quality improvement region based on the feature amount extracted by the feature extraction unit 260, the feature amount extracted by the feature extraction unit 151, and the pose of the object estimated by the pose estimation unit 270. For example, the action may be recognized using the feature amount acquired from the terminal 100 for a region in which the action cannot be recognized or a region in which a score is lower than a predetermined value. Note that the description of units that operate as in FIG. 7 in the first example embodiment is omitted.

Note that the terminal 100 may include a pose estimation unit similar to the pose estimation unit 270, transmit a pose estimation result of the object of the image quality lowering region from the terminal to the center server 200, and perform action recognition of the image quality lowering region by using the transmitted pose estimation result.

As described above, in the present example embodiment, the terminal performs feature amount extraction for the object of the region in which the image quality is lowered, and transmits the extracted feature amount to the center server. The center server performs action recognition for the object of the image quality lowering region by using the received feature amount. As a result, it is possible to perform action recognition based on the feature in the image quality lowering region, and to improve recognition accuracy of the action recognition for the object.

### Third Example Embodiment

Next, a third example embodiment will be described. In the present example embodiment, an example of transmitting related object information of an image quality lowering region together with a distributed video will be described.

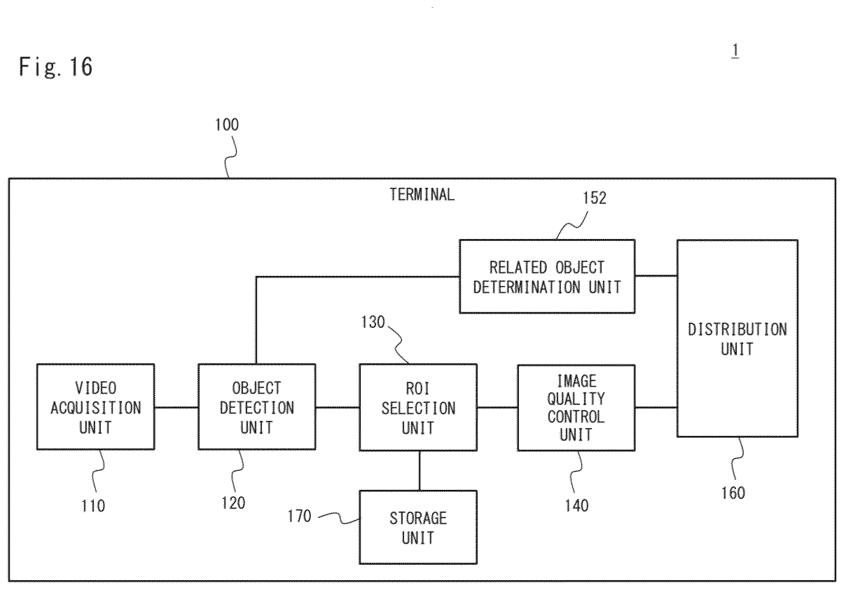

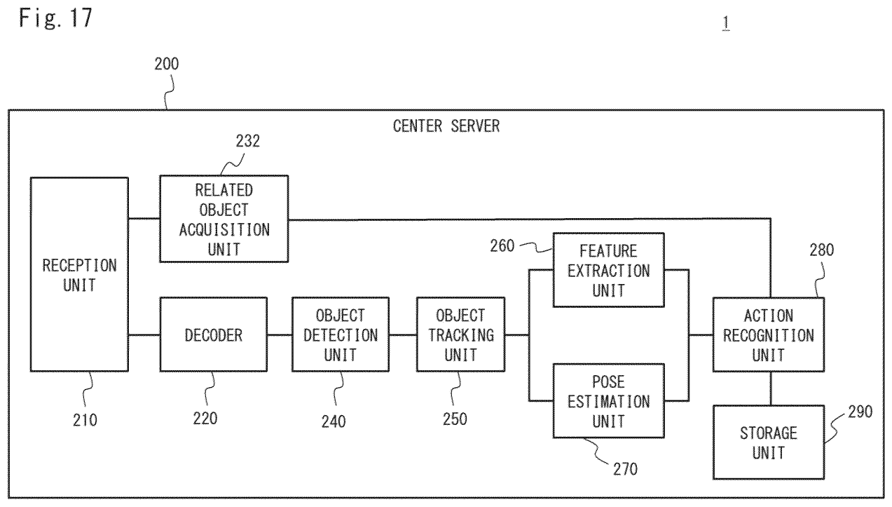

FIG. 16 illustrates a configuration example of a terminal 100 according to the present example embodiment, and FIG. 17 illustrates a configuration example of a center server 200 according to the present example embodiment. Here, a configuration different from that of the first example embodiment will be mainly described.

As illustrated in FIG. 16, in the present example embodiment, the terminal 100 includes a related object determination unit 152 instead of the object detection result extraction unit 150 of the first example embodiment. Other configurations are similar to those in the first example embodiment.

The related object determination unit 152 analyzes a relationship between objects based on detection results of the objects and determines the presence or absence of the related objects that are relevant. The related object determination unit 152 analyzes the relationship between the objects of the image quality lowering region that is not selected as an ROI among the objects detected by an object detection unit 120. The relationship between the objects is a positional relationship such as a distance between the objects or an overlap between regions of the objects. The overlap between the regions of the objects is, for example, intersection over union (IoU) indicating an overlap between object regions which are rectangular regions including the detected objects. In addition, the relationship between the objects may include orientations of the objects. The related object determination unit 152 determines the presence or absence of the relationship between the objects based on the positional relationship between the objects detected in the image quality lowering region and the orientations. For example, in a case where a distance between a first object and a second object is smaller than a predetermined threshold, the related object determination unit 152 may determine that the first object and the second object are relevant. The related object determination unit 152 may determine that the first object and the second object are relevant in a case where an overlap between regions of the first object and the second object is larger than a predetermined threshold. In a case where the first object is oriented toward the second object, the related object determination unit 152 may determine that the first object and the second object are relevant. The relationship between the objects may be determined by any one of the distance between the objects, the overlap between the objects, and the orientations of the objects, or the relationship between the objects may be determined by an arbitrary combination of the distance between the objects, the overlap between the objects, and the orientations of the objects. Note that, in this example, the presence or absence of the relationship between the objects is determined. However, a state in which a person holds an object or the like may be determined based on the distance between the objects, the overlap between the objects, the orientations of the objects, or the like.

The related object determination unit 152 transmits related object information determined to be relevant as a result of analysis to the center server 200 via a distribution unit 160. The related object information includes object detection results of the first object and the second object determined to be relevant in the image quality lowering region, that is, object types, position information, and the like of the first object and the second object. The related object information indicates a relationship between the first object and the second object, that is, a positional relationship. Furthermore, the related object information may include a state in which a person holds an object.

The distribution unit 160 transmits encoded data encoded by an image quality control unit 140 and the related object information of the image quality lowering region analyzed by the related object determination unit 152 to the center server 200. Note that the description of units that operate as in FIG. 6 in the first example embodiment is omitted.

As illustrated in FIG. 17, in the present example embodiment, the center server 200 includes a related object acquisition unit 232 instead of the object detection result acquisition unit 230 of the first example embodiment, and further includes a storage unit 290. Other configurations are similar to those in the first example embodiment.

The storage unit 290 stores an object-work association table in which a work content is associated with an object used in work, that is, a work object.

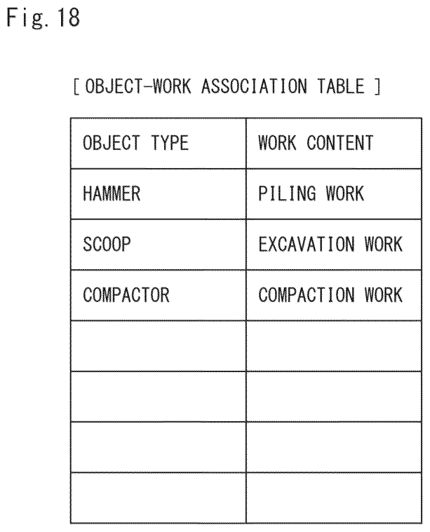

FIG. 18 illustrates an example of the object-work association table. In this example, a hammer is associated with piling work performed using the hammer, a scoop is associated with excavation work performed using the scoop, and a compactor is associated with compaction work performed using the compactor. The work content is not limited to being associated with a tool related to the work, and may be associated with a construction machine related to the work. For example, the excavation work may be associated with an excavator, or concrete work may be associated with a mixer vehicle.

A reception unit 210 receives the encoded data and the related object information of the image quality lowering region transmitted from the terminal 100, and the related object acquisition unit 232 acquires the received related object information of the image quality lowering region. Note that the related object acquisition unit 232 may be integrated with the reception unit 210. The related object determination unit 152 may be disposed in the center server 200, and the center server 200 may analyze the relationship between the objects to acquire the related object information. That is, similarly to the first example embodiment, the terminal 100 may transmit the object detection result of the image quality lowering region, and the related object determination unit 152 of the center server 200 may analyze the relationship between the objects based on the received object detection result of the image quality lowering region and generate the related object information.

The action recognition unit 280 recognizes an action of the object based on a feature amount of the object extracted by a feature extraction unit 260 and a pose of the object estimated by a pose estimation unit 270, and further updates a recognition result of the action based on the related object information acquired from the terminal 100. That is, the recognition result of the action is narrowed down based on the object determined to be relevant, indicated by the related object information. In a case where the related object information includes a state in which a person holds an object or the like, the recognition result of the action may be narrowed down based on the object corresponding to the state.

For example, the action recognition unit 280 increases a score of an action type of the work corresponding to the first object and the second object indicated by the related object information by referring to the object-work association table in the storage unit 290. In a case where actions of a plurality of objects are recognized, the action recognition unit 280 may extract an action recognition result of a corresponding object from types and position information of the first object and the second object indicated by the related object information, and update the extracted action recognition result of the object.

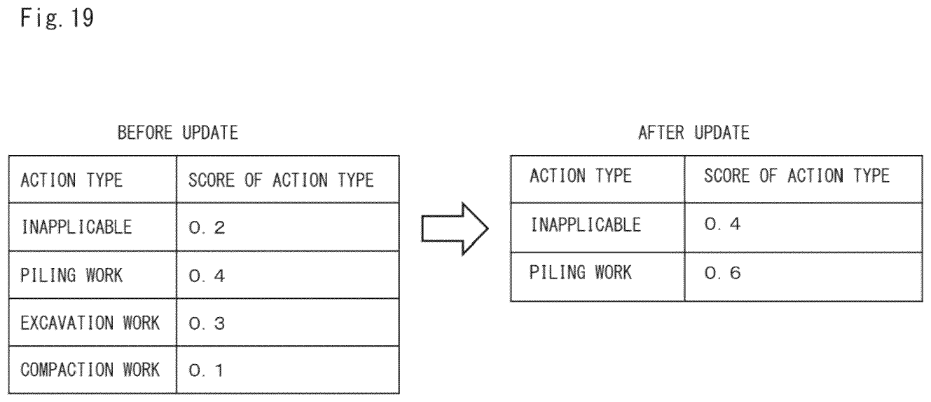

FIG. 19 illustrates a specific example of updating the score of the action type included in the action recognition result based on the related object information. For example, in a case of the example illustrated in FIGS. 9 to 11 of the first example embodiment, since image qualities of regions of the person and the hammer are lowered, the recognition of the person and the hammer becomes ambiguous in the center server 200, and the score of the action type of the piling work to be recognized from the person and the hammer is low. For example, the score of the action type of the piling work is 0.4 before the update as in FIG. 19. In the present example embodiment, in a case where the related object information indicates that the person and the hammer are relevant, the action recognition unit 280 specifies the piling work as the work related to the hammer from the object-work association table of FIG. 18, and narrows down the recognition result by increasing the score of the action type of the specified piling work. For example, the action recognition unit 280 updates the score of the action type of each work such that the score of the action type of the specified work becomes the highest. The score of the action type may be increased by a predetermined value or ratio. The score of the action type other than the specified work may be lowered or deleted. The score of each action type is updated to an arbitrary value such that the total of the scores of all the action types becomes 1.0. For example, the score of the action type of the piling work is updated from 0.4 to 0.6 after the update as in FIG. 19. In addition, the excavation work and the compaction work other than the piling work are deleted, and the score of the action type of inapplicable is updated to 0.4. Note that the description of units that operate as in FIG. 7 in the first example embodiment is omitted.

As described above, in the present example embodiment, the object detection result of the terminal is used for narrowing down action recognition of the center server. If the image quality of the video is lowered, there is a possibility that extraction of the feature amount and pose estimation are not correctly performed, and reliability of the action recognition deteriorates. In order to prevent the deterioration in reliability of the action recognition due to the lowered image quality of the video, in the third example embodiment, the action recognition result is updated from the object detection result of the terminal to narrow down candidates of the action. For example, as information for narrowing down the candidates of the action, information regarding the related objects indicating the relationship such as a predetermined positional relationship is transmitted from the terminal. The center server updates the score of the action corresponding to the related objects to narrow down the candidates of the action. For example, since there is a high possibility that a worker is performing the compaction work because the worker and the compactor are close to each other, the candidates of the action can be narrowed down to the compaction work. As a result, even in a case where a video quality is poor, the action recognition can be performed based on the information regarding the relationship between the objects, and recognition accuracy of the action recognition can be improved.

### Fourth Example Embodiment

Next, a fourth example embodiment will be described.. In the present example embodiment, an example of transmitting a face authentication result of a person together with a distributed video will be described.

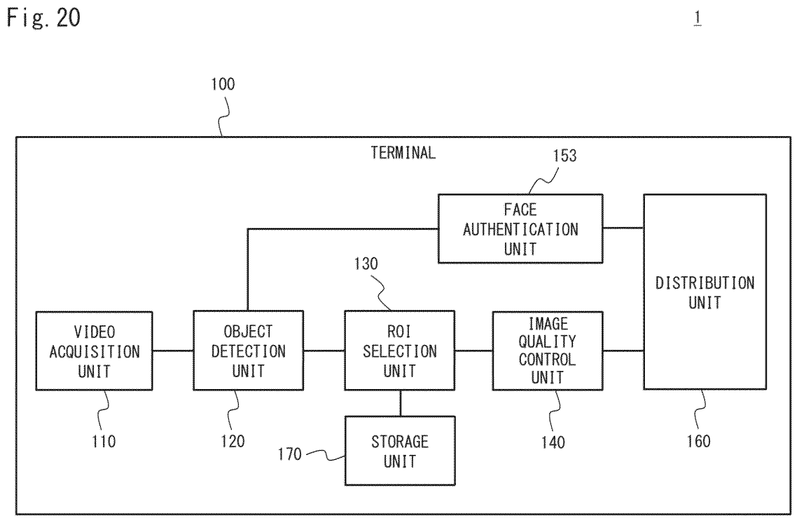

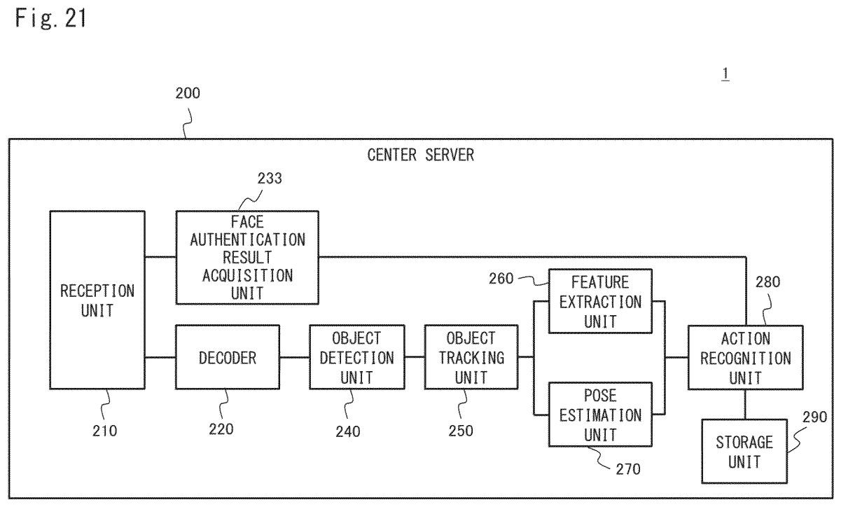

FIG. 20 illustrates a configuration example of a terminal 100 according to the present example embodiment, and FIG. 21 illustrates a configuration example of a center server 200 according to the present example embodiment. Here, a configuration different from that of the first example embodiment will be mainly described.

As illustrated in FIG. 20, in the present example embodiment, the terminal 100 includes a face authentication unit 153 instead of the object detection result extraction unit 150 of the first example embodiment. Other configurations are similar to those in the first example embodiment.

The face authentication unit 153 performs face authentication of a person detected by object detection. The face authentication unit 153 is a specifying unit that specifies an individual by the face authentication. For example, specification information for specifying the individual and person identification information for identifying the person are stored in a storage unit 170 in association with each other. The specification information includes, for example, an image of a face of the person. The face authentication unit 153 extracts a face of a person in a frame, and compares the extracted face with the face of the person included in the specification information registered in the storage unit 170. For example, the face authentication unit 153 may authenticate the face of the person in the frame by a face authentication engine using machine learning such as deep learning. The face authentication unit 153 transmits the person identification information of the person whose face authentication has succeeded to the center server 200 via a distribution unit 160 as a face authentication result. The person identification information is identification information for identifying the individual specified by face authentication, and may be, for example, a name of each person or an identification number assigned to each person. The face authentication result may include position information of the specified person. The face authentication unit 153 may transmit the face authentication result of the person detected in all regions, or may transmit the face authentication result of the person detected in an image quality lowering region.

The distribution unit 160 transmits encoded data encoded by an image quality control unit 140 and the face authentication result of the face authentication unit 153 to the center server 200. Note that the description of units that operate as in FIG. 6 in the first example embodiment is omitted.

As illustrated in FIG. 21, in the present example embodiment, the center server 200 includes a face authentication result acquisition unit 233 instead of the object detection result acquisition unit 230 of the first example embodiment, and further includes a storage unit 290. Other configurations are similar to those in the first example embodiment.

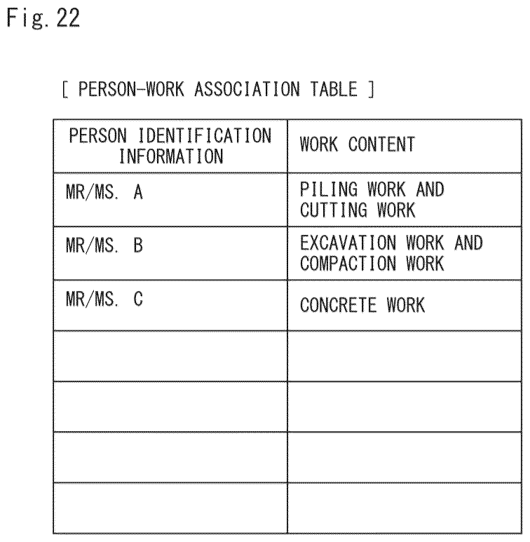

The storage unit 290 stores a person-work association table in which a work content performed by the person is associated with the person. FIG. 22 illustrates an example of the person-work association table. As illustrated in FIG. 22, in the person-work association table, the work content performed by the person is associated with each piece of person identification information. The person identification information is the same identification information as the person identification information for identifying the person whose terminal is specified by the face authentication. That is, the person identification information may be the name of each person or the identification number assigned to each person. In this example, piling work and cutting work performed by Mr/Ms. A are associated with Mr/Ms. A, excavation work and compaction work performed by Mr/Ms. B are associated with Mr/Ms. B, and concrete work performed by Mr/Ms. C is associated with Mr/Ms. C. In this manner, one work may be associated with each person, or a plurality of works may be associated with each person. In a case where a plurality of works is associated with the person, a date and time for performing each work may be set.

A reception unit 210 receives the encoded data and the face authentication result transmitted from the terminal 100, and the face authentication result acquisition unit 233 acquires the received face authentication result. Note that the face authentication result acquisition unit 233 may be integrated with the reception unit 210. In addition, the face authentication unit 153 may be disposed in the center server 200, the face of the person may be authenticated in the center server 200, and the face authentication result may be acquired. That is, the terminal 100 may transmit an image of the face of the person or a feature amount of the image of the face, and the face authentication unit 153 of the center server 200 may authenticate the face of the person based on the received image of the face of the person or feature amount of the image of the face, and generate the face authentication result.

The action recognition unit 280 recognizes an action of an object based on a feature amount of the object extracted by a feature extraction unit 260 and a pose of the object estimated by a pose estimation unit 270, and further updates a recognition result of the action based on the face authentication result acquired from the terminal 100. That is, the recognition result of the action is narrowed down based on the person identification information indicating the individual specified by the face authentication. The action recognition unit 280 updates a score of an action type of the work corresponding to the person identification information indicating the individual specified by the face authentication by referring to the person-work association table in the storage unit 290. In a case where actions of a plurality of persons are recognized, the action recognition unit 280 may extract an action recognition result of a corresponding person from position information of the face authentication result and update the action recognition result of the extracted person.

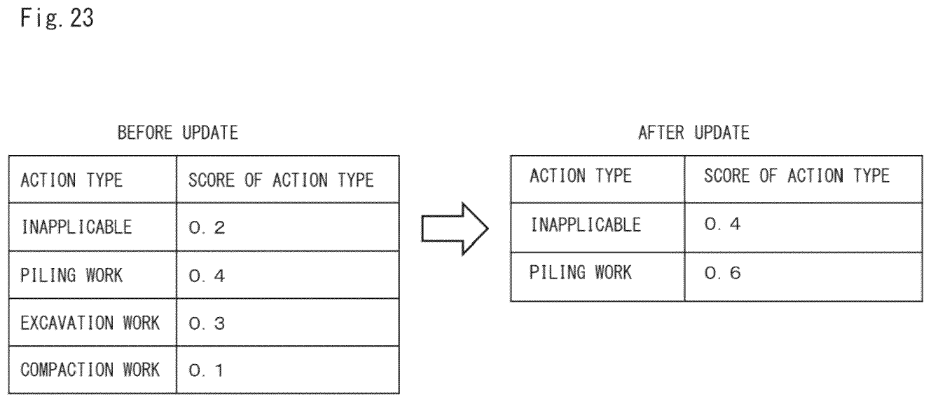

FIG. 23 illustrates a specific example of updating the score of the action type included in the action recognition result based on the face authentication result. For example, in a case of the example illustrated in FIGS. 9 to 11 of the first example embodiment, since image qualities of regions of the person and a hammer are lowered, recognition of the person and the hammer becomes ambiguous in the center server 200, and the score of the action type of the piling work to be recognized from the person and the hammer is low. For example, the score of the action type of the piling work is 0.4 before the update as in FIG. 23. In the present example embodiment, in a case where the person is identified as Mr/Ms. A based on the face authentication result, the action recognition unit 280 specifies that the work related to Mr/Ms. A is the piling work or the cutting work based on the person-work association table of FIG. 22. In this example, since the recognition result includes the piling work, the recognition result is narrowed down by increasing the score of the action type of the piling work. In a case where a date and time when Mr/Ms. A performs the piling work and the cutting work is set, the score of the action type to be updated may be selected based on the set time and the current time. The action recognition unit 280 updates the score of the action type of each work such that the score of the action type of the specified work becomes the highest. A method of updating the score of the action type of the specified work is similar to that in the third example embodiment. For example, the score of the action type of the piling work is updated from 0.4 to 0.6 after the update as in FIG. 23. In addition, the excavation work and the compaction work other than the piling work are deleted, and the score of the action type of inapplicable is updated to 0.4. Note that the description of units that operate as in FIG. 7 in the first example embodiment is omitted.

Note that the present disclosure is not limited to an example of specifying the individual by the face authentication and identifying the specified person. Similarly to the face authentication, an object other than the person may be specified, and the specified object may be identified. That is, identification information for identifying the specified object may be transmitted from the terminal, and the action recognition result may be narrowed down. For example, a table in which an identifiable object such as a heavy machine, a forklift, or an automatic guided vehicle (AGV) is associated with work may be held, and the action recognition result of the object may be narrowed down based on an identification result of the object and the table. In addition, not only the identification information for identifying the specified object but also attribute identification information for identifying an attribute or a group of the object may be transmitted from the terminal, and the action recognition result may be narrowed down. For example, a job category such as a carpenter or a plasterer, a company to which the person belongs, or the like may be identified as the attribute or the group of the person, and the action recognition result corresponding to the job category or the company may be updated. The job category or the company may be identified from clothes such as a work wear of the person, a helmet, a hat, or the like. For example, the job category or the company may be identified from characters, marks, and the like on the work wear or the helmet. Furthermore, for example, the job category or the company may be identified from a code or the like indicating the attribute or the group, attached to or displayed on an object such as a machine or clothes.

As described above, in the present example embodiment, the identification result of the individual and the attribute of the person, such as the face authentication result in the terminal, is used for narrowing down action recognition of the center server. If the image quality of the video is lowered, there is a possibility that extraction of the feature amount and pose estimation are not correctly performed, and reliability of the action recognition deteriorates. In order to prevent the deterioration in reliability of the action recognition due to the lowered image quality of the video, in the fourth example embodiment, the face authentication or the like of the person is performed in the terminal, the work corresponding to the identified person or the like is specified, and candidates of the work are narrowed down by the specified work. As a result, recognition accuracy can be improved in a case where a video quality is poor. In addition, not only the face authentication result but also the identification result of the object can be used.

### Fifth Example Embodiment

Next, a fifth example embodiment will be described. In the present example embodiment, an example in which an ROI is selected based on a relationship between objects in the configurations of the first to fourth example embodiments will be described.

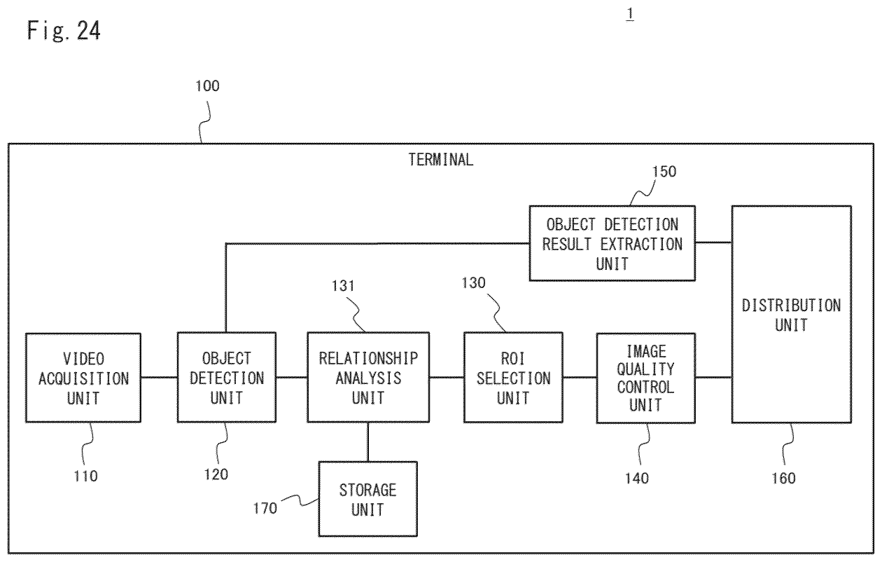

FIG. 24 illustrates a configuration example of a terminal 100 according to the present example embodiment. Since a configuration of a center server 200 is similar to that of the first example embodiment, a description thereof will be omitted. Note that an example in which the present example embodiment is applied to the first example embodiment will be described as an example, but the present example embodiment may be similarly applied to the second to fourth example embodiments.

As illustrated in FIG. 24, in the present example embodiment, the terminal 100 includes a relationship analysis unit 131 in addition to the configuration of the first example embodiment. Other configurations are similar to those in the first example embodiment. Here, a configuration different from that of the first example embodiment will be mainly described.

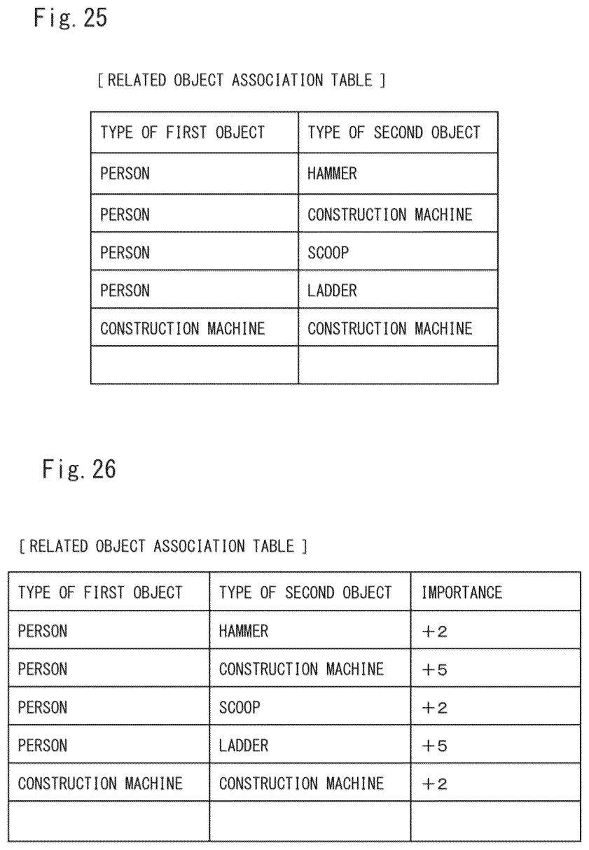

A storage unit 170 stores a table for analyzing the relationship between the objects. Specifically, a related object association table in which a pair of related objects for analyzing the relationship is associated is stored. FIG. 25 illustrates a specific example of the related object association table. As illustrated in FIG. 25, in the related object association table, a type of a first object and a type of a second object are associated with each other as the related objects for analyzing the relationship. In this example, a hammer, a construction machine, a scoop, and a ladder are associated with each person, and the construction machine and the construction machine are associated with each other. For example, the related object association table may define a pair of objects corresponding to recognition targets recognized from a video by the center server 200. In a case where the center server 200 recognizes work performed by the person, a work object used for the work, for example, the hammer or the scoop, is associated with the person who performs the work. In this case, one of the first object and the second object is the person, and the other is the work object. In a case of recognizing the work performed by two construction machines, the construction machine and the construction machine are associated with each other. In this case, the first object and the second object are the work objects. Furthermore, in a case where the center server 200 recognizes an unsafe action in which the person is in a dangerous state, the object that induces the unsafe action, for example, the construction machine or the ladder, is associated with the person. In this case, one of the first object and the second object becomes the person, and the other becomes the object that induces the unsafe action.

FIG. 26 illustrates another example of the related object association table. As illustrated in FIG. 26, in the related object association table, an assigned importance may be associated with the related object to be analyzed, that is, the pair of the first object and the second object. For example, the importance may be set according to the recognition target recognized from the video by the center server 200. The importance of a pair of the person and the construction machine or a pair of the person and the ladder related to the unsafe action may be set higher than that of a pair of the person and the hammer or a pair of the person and the scoop related to the work. For example, an importance of +5 is assigned to a region of the person close to the construction machine or a region of the person overlapping the construction machine, and an importance of +2 is assigned to a region of the person close to the hammer or a region of the person overlapping the hammer. The importance of +5 may be assigned to the region of the person based only on a combination of the person and the construction machine, and the importance of +2 may be assigned to the region of the person based only on a combination of the person and the hammer. Note that the importance is not limited to a numerical value, and may be a level such as high, medium, or low.

The relationship analysis unit 131 analyzes the relationship between the objects based on a detection result of the object detected in an input video. The relationship analysis unit 131 analyzes the relationship between the objects having a predetermined type among the detected objects. The relationship analysis unit 131 analyzes a relationship between the first object and the second object associated in the related object association table by referring to the related object association table stored in the storage unit 170. The relationship between the objects is a positional relationship such as a distance between the objects or an overlap between the regions of the objects. In addition, the relationship between the objects may include orientations of the objects. The relationship analysis unit 131 may determine the presence or absence of the relationship between the objects based on the positional relationship between the objects or orientations of the objects.

The relationship analysis unit 131 may determine the presence or absence of the relationship between the objects, similarly to the related object determination unit 152 of the third example embodiment. For example, in a case where a distance between the first object and the second object is smaller than a predetermined threshold, the relationship analysis unit 131 may determine that the first object and the second object are relevant. For example, the relationship analysis unit 131 determines that the person and the hammer are relevant in a case where a distance between the person and the hammer is smaller than a threshold by referring to the related object association table of FIG. 25. In addition, the relationship analysis unit 131 may determine that the first object and the second object are relevant in a case where an overlap between the regions of the first object and the second object is larger than a predetermined threshold. In a case where the first object is oriented toward the second object, the relationship analysis unit 131 may determine that the first object and the second object are relevant. The relationship between the objects may be determined by any one of the distance between the objects, the overlap between the objects, and the orientations of the objects, or the relationship between the objects may be determined by an arbitrary combination of the distance between the objects, the overlap between the objects, and the orientations of the objects.

Furthermore, the relationship analysis unit 131 may assign the importance to the region of the object according to the positional relationship between the objects or the orientations of the objects. That is, the relationship analysis unit 131 may function as an importance determination unit that determines the importance. The importance determination unit may be mounted on the terminal 100 separately from the relationship analysis unit. The importance is the degree of gaze required, and indicates a priority of sharpening. For example, in a case where the importance is set for each related object in the related object association table, the relationship analysis unit 131 may assign the importance to the region of the object based on the setting of the related object association table. For example, the relationship analysis unit 131 assigns the importance of +2 to the regions of the person and the hammer in a case where the distance between the person and the hammer is smaller than the threshold by referring to the related object association table of FIG. 26. The relationship analysis unit 131 may increase the importance to be assigned as the distance between the first object and the second object decreases. The relationship analysis unit 131 may increase the importance to be assigned as the overlap between the regions of the first object and the second object increases. The relationship analysis unit 131 may increase the importance to be assigned as the orientation of the first object approaches the second object. In addition, the importance may be assigned based only on a combination of the objects.

An ROI selection unit 130 selects the ROI in the acquired input video based on the analyzed relationship between the objects. For example, the ROI selection unit 130 may select, as the ROIs, the regions of the first object and the second object determined to be relevant. In addition, the ROI selection unit 130 may select the ROI according to the assigned importance of the region. In addition, in a case where the importance corresponding to the relationship between the first object and the second object is equal to or higher than a predetermined value, the region of the first object and the region of the second object may be selected as the ROIs. The ROI may be selected in descending order of the importance assigned to the region of each object. For example, a predetermined number of regions with the highest importances may be selected as the ROIs. A number of regions that can be sharpened within a range of a bit rate assigned from a compression bit rate control function 401 may be selected as the ROIS.

In addition, the ROI selection unit 130 may select the ROI according to a change in the relationship between the objects. That is, the importance may be changed according to a time-series change of the distance or the overlap between the objects, and the ROI may be determined based on the changed importance. For example, in a case where an excavator is detected around a location where soil is piled, the importance may be changed according to whether or not the excavator is moving, that is, a change in the distance or overlap between the piled soil and the excavator. In this case, there may be a case where the excavator is stopped and root cutting work is performed, and a case where the excavator moves and backfilling work is performed. Therefore, in a case where the excavator is moving, a region of the moving excavator may be set as the ROI by increasing the importance. Note that the description of units that operate as in FIG. 6 in the first example embodiment is omitted.

As described above, in the present example embodiment, in the configurations of the first to fourth example embodiments, in a case where the ROI is selected by the terminal, the ROI is selected based on the relationship such as the positional relationship between the objects detected in the video. As a result, the ROI can be appropriately selected based on the relationship between the objects, and for example, object detection in an important region can be performed in the center server having more resources than the terminal. Similarly to the first to fourth example embodiments, recognition accuracy for the image quality lowering region that is not selected as the ROI can be improved.

### Sixth Example Embodiment

Next, a sixth example embodiment will be described. In the present example embodiment, an example in which an ROI is selected based on an object related to a situation of work in the configurations of the first to fourth example embodiments will be described.

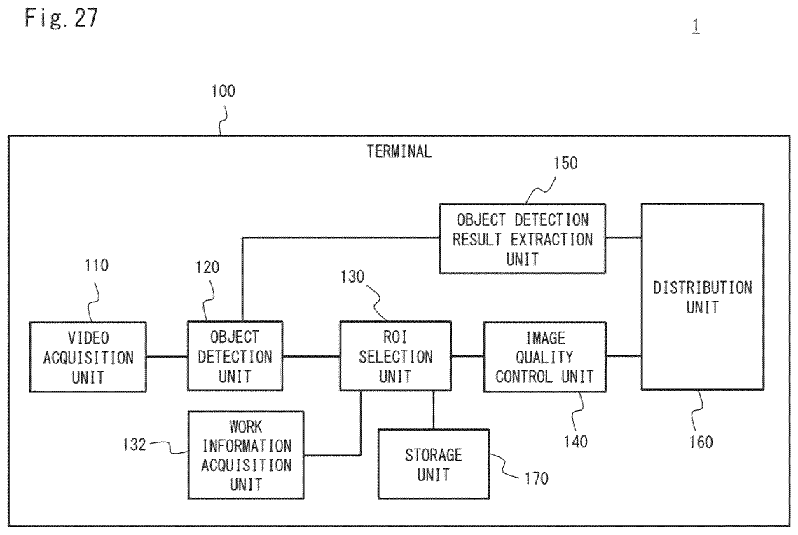

FIG. 27 illustrates a configuration example of a terminal 100 according to the present example embodiment. Since a configuration of a center server 200 is similar to that of the first example embodiment, a description thereof will be omitted. Note that an example in which the present example embodiment is applied to the first example embodiment will be described as an example, but the present example embodiment may be similarly applied to the second to fourth example embodiments.

As illustrated in FIG. 27, in the present example embodiment, the terminal 100 includes a work information acquisition unit 132 in addition to the configuration of the first example embodiment. Other configurations are similar to those in the first example embodiment. Note that it can also be said that the terminal 100 includes the work information acquisition unit 132 instead of the relationship analysis unit 131 of the fifth example embodiment. Here, a configuration different from that of the first example embodiment will be mainly described.

The work information acquisition unit 132 acquires work information indicating the situation of the work performed in a site. The work information may be information for specifying a work content of the currently performed work or schedule information including a date and time of each work process. The work information may be input by a worker or may be acquired from a management apparatus that manages the work process.

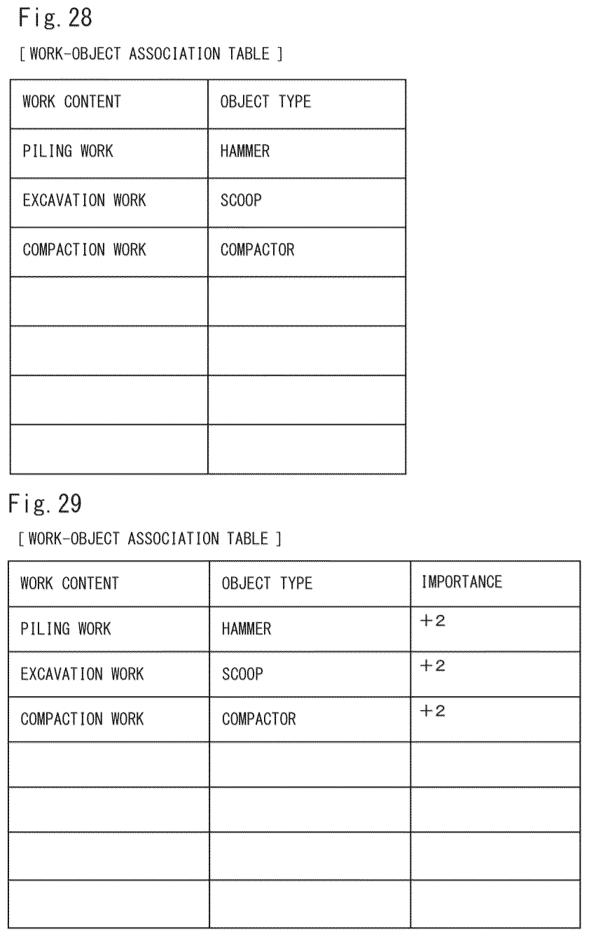

A storage unit 170 stores a work-object association table in which the work content is associated with the object used in the work, that is, a work object. FIG. 28 illustrates an example of the work-object association table. As illustrated in FIG. 28, in the work-object association table, the work content or the work process is associated with a type of the object used in the work. In this example, a hammer used in piling work is associated with the piling work, a scoop used in excavation work is associated with excavation work, and a compactor used in compaction work is associated with the compaction work. The object is not limited to a tool related to the work, and may be a construction machine related to the work. For example, an excavator may be associated with the excavation work, or a mixer vehicle may be associated with concrete work. FIG. 29 illustrates another example of the work-object association table. As illustrated in FIG. 29, in the work-object association table, an importance may be associated with the object corresponding to each work, similarly to the fifth example embodiment.

The ROI selection unit 130 selects the ROI in an input video based on the work information acquired by the work information acquisition unit 132. The ROI selection unit 130 specifies the current work from the input current work content and the schedule information of the work process. For example, in a case where the schedule information defines the work on X month Y day in the morning as the compaction work, if the current date and time is X month Y day in the morning, it is determined that the current work is the compaction work. The ROI selection unit 130 specifies the work object corresponding to the current work by referring to the work-object association table in the storage unit 170.

The ROI selection unit 130 extracts the object having the type of the work object corresponding to the work from among the detected objects detected in the input video, and selects a rectangular region of the extracted object as the ROI. In the example of the work-object association table of FIG. 28, in a case where the current work is the compaction work, a region of the compactor associated with the compaction work is determined as the ROI.

In a case where the importance is set for each work object in the work-object association table, the ROI selection unit 130 assigns the importance to the extracted object based on the setting of the work-object association table, and selects the ROI based on the assigned importance. In the example of the work-object association table of FIG. 29, in a case where the current work is the compaction work, an importance of +2 is assigned to the region of the compactor associated with the compaction work, and the ROI is selected based on the assigned importance. Note that the description of units that operate as in FIG. 6 in the first example embodiment is omitted.

As described above, in the present example embodiment, in the configurations of the first to fourth example embodiments, in a case where the ROI is selected by the terminal, the ROI is selected based on the object related to the work performed in the video. As a result, the ROI can be appropriately selected according to the situation of the work, and for example, object detection in an important region can be performed in the center server having more resources than the terminal. Similarly to the first to fourth example embodiments, recognition accuracy for the image quality lowering region that is not selected as the ROI can be improved.

Note that the present disclosure is not limited to the above-described example embodiments, and can be appropriately modified without departing from the scope.

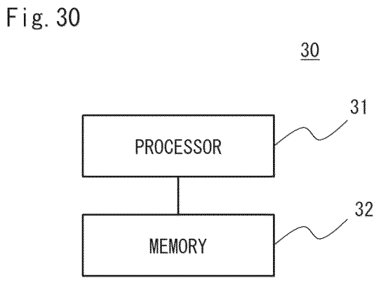

Each configuration in the above-described example embodiments may be implemented by hardware, software, or both, and may be implemented by one piece of hardware or software or by a plurality of pieces of hardware or software. The apparatuses and functions (processing) may be realized by a computer 30 including a processor 31, such as a central processing unit (CPU), and a memory 32, which is a storage device, as illustrated in FIG. 30. For example, programs for performing the methods (video processing methods) in the example embodiments may be stored in the memory 32, and the functions may be realized by the processor 31 executing the programs stored in the memory 32.

These programs include a group of commands (or software codes) causing a computer to perform one or more of the functions described in the example embodiments in a case of being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. As an example and not by way of limitation, transitory computer-readable or communication media include electrical, optical, acoustic, or other forms of propagated signals.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following Supplementary Notes, but are not limited to the following Supplementary Notes.

### Supplementary Note 1

A video processing system including:
first object detection means for detecting an object included in an input video;
image quality control means for controlling an image quality of a region including the object in the video based on a detection result of the object; and
transmission means for transmitting the detection result of the object and the video in which the image quality is controlled.

### Supplementary Note 2

The video processing system according to Supplementary Note 1, in which the transmission means transmits the detection result of the object included in the region in which the image quality is controlled to be lower than image qualities of other regions among the detected objects.

### Supplementary Note 3

The video processing system according to Supplementary Note 1 or 2, in which the transmission means transmits a type of the object and position information of the object, as the detection result of the object.

### Supplementary Note 4

The video processing system according to any one of Supplementary Notes 1 to 3, in which the transmission means transmits a feature amount of the region including the object, as the detection result of the object.

### Supplementary Note 5

The video processing system according to any one of Supplementary Notes 1 to 4, in which the transmission means transmits a positional relationship between a first object and a second object, as the detection result of the object.

### Supplementary Note 6

The video processing system according to any one of Supplementary Notes 1 to 5, further including identification means for identifying a detected person based on the detected person and specification information for specifying an individual from among the detected objects,
in which the transmission means transmits person identification information for identifying the specified person, as the detection result of the object.

### Supplementary Note 7

The video processing system according to any one of Supplementary Notes 1 to 5, in which the transmission means transmits attribute identification information for identifying an attribute of the object, as the detection result of the object.

### Supplementary Note 8

The video processing system according to any one of Supplementary Notes 1 to 7, further including state recognition means for recognizing a state of the object in the transmitted video by using the transmitted detection result of the object.

### Supplementary Note 9

A video processing apparatus including:
object detection means for detecting an object included in an input video;
image quality control means for controlling an image quality of a region including the object in the video based on a detection result of the object; and
transmission means for transmitting the detection result of the object and the video in which the image quality is controlled.

### Supplementary Note 10

The video processing apparatus according to Supplementary Note 9, in which the transmission means transmits the detection result of the object included in the region in which the image quality is controlled to be lower than image qualities of other regions among the detected objects.

### Supplementary Note 11

The video processing apparatus according to Supplementary Note 9 or 10,in which the transmission means transmits a type of the object and position information of the object, as the detection result of the object.

### Supplementary Note 12

The video processing apparatus according to any one of Supplementary Notes 9 to 11, in which the transmission means transmits a feature amount of the region including the object, as the detection result of the object.

### Supplementary Note 13

The video processing apparatus according to any one of Supplementary Notes 9 to 12, in which the transmission means transmits a positional relationship between a first object and a second object, as the detection result of the object.

### Supplementary Note 14

The video processing apparatus according to any one of Supplementary Notes 9 to 13, further including identification means for identifying a detected person based on the detected person and specification information for specifying an individual from among the detected objects,
in which the transmission means transmits person identification information for identifying the specified person, as the detection result of the object.

### Supplementary Note 15

The video processing apparatus according to any one of Supplementary Notes 9 to 13, in which the transmission means transmits attribute identification information for identifying an attribute of the object, as the detection result of the object.

### Supplementary Note 16

A video processing method including:
detecting an object included in an input video;
controlling an image quality of a region including the object in the video based on a detection result of the object; and
transmitting the detection result of the object and the video in which the image quality is controlled.

### Supplementary Note 17

The video processing method according to Supplementary Note 16, in which the detection result of the object included in the region in which the image quality is controlled to be lower than image qualities of other regions among the detected objects is transmitted.

### Supplementary Note 18

The video processing method according to Supplementary Note 16 or 17, in which a type of the object and position information of the object are transmitted as the detection result of the object.

### Supplementary Note 19

The video processing method according to any one of Supplementary Notes 16 to 18, in which a feature amount of the region including the object is transmitted as the detection result of the object.

### Supplementary Note 20

The video processing method according to any one of Supplementary Notes 16 to 19, in which a positional relationship between a first object and a second object is transmitted as the detection result of the object.

### Supplementary Note 21

The video processing method according to any one of Supplementary Notes 16 to 20, in which
a detected person is specified based on the detected person and specification information for specifying an individual from among the detected objects, and
person identification information for identifying the specified person is transmitted as the detection result of the object.

### Supplementary Note 22

The video processing method according to any one of Supplementary Notes 16 to 20, in which attribute identification information for identifying an attribute of the object is transmitted as the detection result of the object.

### Supplementary Note 23

A video processing program for causing a computer to perform processing of:
detecting an object included in an input video;
controlling an image quality of a region including the object in the video based on a detection result of the object; and
transmitting the detection result of the object and the video in which the image quality is controlled.

### Supplementary Note 24

The video processing system according to any one of Supplementary Notes 1 to 6, further including second object detection means for detecting an object in the transmitted video by using the transmitted detection result of the object.

### REFERENCE SIGNS LIST

1 REMOTE MONITORING SYSTEM
10 VIDEO PROCESSING SYSTEM
11 OBJECT DETECTION UNIT
12 IMAGE QUALITY CONTROL UNIT
20 VIDEO PROCESSING APPARATUS
30 COMPUTER
31 PROCESSOR
32 MEMORY
100 TERMINAL
101 CAMERA
102 COMPRESSION EFFICIENCY OPTIMIZATION FUNCTION
110 VIDEO ACQUISITION UNIT
120 OBJECT DETECTION UNIT
130 ROI SELECTION UNIT
131 RELATIONSHIP ANALYSIS UNIT
132 WORK INFORMATION ACQUISITION UNIT
140 IMAGE QUALITY CONTROL UNIT
150 OBJECT DETECTION RESULT EXTRACTION UNIT
151 FEATURE EXTRACTION UNIT
152 RELATED OBJECT DETERMINATION UNIT
153 FACE AUTHENTICATION UNIT
160 DISTRIBUTION UNIT
170 STORAGE UNIT
200 CENTER SERVER
201 VIDEO RECOGNITION FUNCTION
202 ALERT GENERATION FUNCTION
203 GUI DRAWING FUNCTION
204 SCREEN DISPLAY FUNCTION
210 RECEPTION UNIT
220 DECODER
230 OBJECT DETECTION RESULT ACQUISITION UNIT
231 FEATURE ACQUISITION UNIT
232 RELATED OBJECT ACQUISITION UNIT
233 FACE AUTHENTICATION RESULT ACQUISITION UNIT
240 OBJECT DETECTION UNIT
250 OBJECT TRACKING UNIT
260 FEATURE EXTRACTION UNIT
280 ACTION RECOGNITION UNIT
290 STORAGE UNIT
300 BASE STATION
400 MEC
401 COMPRESSION BIT RATE CONTROL FUNCTION

What is claimed is:

1. A video processing system comprising:
a memory configured to store instructions, and a processor configured to execute the instructions to;
detect an object included in an input video;
control an image quality of a region including the object in the video based on a detection result of the object; and
transmission transmit the detection result of the object and the video in which the image quality is controlled.

2. The video processing system according to claim 1, wherein the processor is further configured to execute the instructions to transmit the detection result of the object included in the region in which the image quality is controlled to be lower than image qualities of other regions among the detected objects.

3. The video processing system according to claim 1, wherein the processor is further configured to execute the instructions to transmit a type of the object and position information of the object, as the detection result of the object.

4. The video processing system according to claim 1, wherein the processor is further configured to execute the instructions to the transmit a feature amount of the region including object, as the detection result of the object.

5. The video processing system according to claim 1, wherein the processor is further configured to execute the instructions to transmit a positional relationship between a first object and a second object, as the detection result of the object.

6. The video processing system according to claim 1, wherein the processor is further configured to execute the instructions to comprising identify a detected person based on the detected person and specification information for specifying an individual from among the detected objects, and
transmit person identification information for identifying the specified person, as the detection result of the object.

7. The video processing system according to claim 1, wherein the processor is further configured to execute the instructions to transmit attribute identification information for identifying an attribute of the object, as the detection result of the object.

8. The video processing system according to claim 1, wherein the processor is further configured to execute the instructions to recognize a state of the object in the transmitted video by using the transmitted detection result of the object.

9. A video processing apparatus comprising:
a memory configured to store instructions, and
a processor configured to execute the instructions to;
object detection means for detecting detect an object included in an input video;
control an image quality of a region including the object in the video based on a detection result of the object; and
transmit the detection result of the object and the video in which the image quality is controlled.

10. The video processing apparatus according to claim 9, wherein the processor is further configured to execute the instructions to transmit the detection result of the object included in the region in which the image quality is controlled to be lower than image qualities of other regions among the detected objects.

11. The video processing apparatus according to claim wherein the processor is further configured to execute the instructions to transmit a type of the object and position information of the object as the detection result of the object.

12. The video processing apparatus according to claim 9, wherein the processor is further configured to execute the instructions to transmit a feature amount of the region including the object, as the detection result of the object.

13. The video processing apparatus according to claim 9, wherein the processor is further configured to execute the instructions to transmit a positional relationship between a first object and a second object, as the detection result of the object.

14. The video processing apparatus according to claim 9, wherein the processor is further configured to execute the instructions to comprising identification means for identifying identify a detected person based on the detected person and specification information for specifying an individual from among the detected objects, and
transmit person identification information for identifying the specified person as the detection result of the object.

15. The video processing apparatus according to claim 9, wherein the processor is further configured to execute the instructions to
transmit attribute identification information for identifying an attribute of the object, as the detection result of the object.

16. A video processing method comprising:
detecting an object included in an input video;
controlling an image quality of a region including the object in the video based on a detection result of the object; and
transmitting the detection result of the object and the video in which the image quality is controlled.

17. The video processing method according to claim 16, wherein the detection result of the object included in the region in which the image quality is controlled to be lower than image qualities of other regions among the detected objects is transmitted.

18. The video processing method according to claim 16, wherein a type of the object and position information of the object are transmitted as the detection result of the object.

19. The video processing method according to claim 16, wherein a feature amount of the region including the object is transmitted as the detection result of the object.

20. The video processing method according to claim 16, wherein a positional relationship between a first object and a second object is transmitted as the detection result of the object.

21.-22. (canceled)
